(19) United States
(12) Patent Application Publication
(10) Pub. No.: US 2003/0068042 A1
(43) Pub. Date: Apr. 10, 2003

(54) Image processing method and apparatus

(76) Inventors: Kozo Akiyoshi, Tokyo (JP); Nobuo Akiyoshi, Tokyo (JP)

Correspondence Address: Dowell & Dowell, P.C., Suite 309, 1215 Jefferson Davis Highway, Arlington, VA, 22202, US

(21) Appl. No.: 10/188,983

(22) Filed: Jul. 5, 2002

(30) Foreign Application Priority Data
Jul. 4, 2001 (JP) 2001-203953

(51) Int. Cl. H04N 7/167

(52) U.S. Cl. 380/210; 348/423.1; 382/100

(57) ABSTRACT

An image processing method and apparatus for encoding and decoding image and sound data in which sound or other data is imprinted into key frame images. In encoding, an image input unit receives a first image and a second image (key frames). A matching processor performs a pixel-by-pixel matching between the images and transmits a corresponding point file to an imprinting unit. Sound data acquired by a sound input unit are also transmitted to the imprinting unit. The corresponding point file and the sound data are imprinted into the first image and an altered first image is generated. In decoding, the corresponding point file and sound data are extracted, the corresponding point file is used to generate intermediate images between the key frames to provide a motion picture, and the sound data is reproduced in synchronization with the motion picture.

### BACKGROUND OF THE INVENTION

1. Field of the Invention

The present invention relates to image processing techniques and more particularly relates to method and apparatus for coding and decoding image and sound data in a compact and secure manner.

2. Description of the Related Art

Recently, image processing and compression methods such as those proposed by MPEG (Motion Picture Expert Group) have expanded to be used with transmission media such as network and broadcast rather than just storage media such as CDs. Generally speaking, the success of the digitization of broadcast materials has been caused at least in part by the availability of MPEG compression coding technology. In this way, a barrier that previously existed between broadcast and other types of communication has begun to disappear, leading to a diversification of service-providing businesses. Thus, we are facing a situation where it is hard to predict how digital culture will evolve in this age of broadband.

Even in such a chaotic situation, it is clear that the direction of the compression technology of motion pictures will be to move to both higher compression rates and better image quality. It is well-known that block distortion in MPEG compression is sometimes responsible for causing degraded image quality and preventing the compression rate from being improved.

### SUMMARY OF THE INVENTION

The present invention has been developed in view of the above situation and, accordingly, is intended to provide encoding and decoding techniques which provide efficient compression of image data while maintaining good image quality. A further intention is to provide a distribution model in which copyrights are better protected when distributing encoded motion pictures.

The embodiments of the present invention generally relate to an image processing technology. This technology may utilize the image matching technology (hereinafter referred to and described as the “base technology”) which has been proposed in Japanese patent No. 2927350, and U.S. Pat. Nos. 6,018,592 and 6,137,910, assigned to the same assignee, which are hereby incorporated by reference.

An embodiment of the present invention relates to an image processing apparatus and more particularly relates to an image encoding apparatus. The image encoding apparatus comprises an image input unit which acquires images, a data unit which acquires data which is to be used with the images, and an imprinting unit which imprints the data into the acquired images. In a particular case, the data may be sound data which is to be reproduced together with the images. It will be understood that the “sound data” may be a human voice, music or other arbitrary audio data. In another particular case, the data may be or may also be information of corresponding points between images, which is to be utilized in generating intermediate images.

Another embodiment of the present invention also relates to an image processing apparatus. This apparatus comprises an image input unit which acquires a plurality of key frames and information of corresponding points between the key frames, an imprinting unit which imprints sound data into any one or more of the key frames, wherein the sound data is to be reproduced synchronously with the key frames when displaying the key frames as a motion picture, including intermediate frames generated by interpolation based on the information of the corresponding points. In a particular case, this apparatus may also comprise a corresponding point information generator which detects the information of the corresponding points.

In this embodiment, the imprinting unit may also imprint the information of the corresponding points into one or more of the key frames in addition to the sound data. The imprinting unit may also control the amount of the sound data to be imprinted according to a time interval between a key frame to which the sound data are imprinted and a key frame adjacent to the imprinted key frame. In particular, depending on the interval between key frames, the amount of sound data may be different. As an example, the quantity of sound data imprinted into a key frame KF2 may be twice that of the sound data imprinted into a key frame KF1 when the time interval between key frames KF2 and KF3 is two seconds but the time interval between key frames KF1 and KF2 is one second. It is natural that the correspondence between the sound data and the key frames is determined according to, and especially in proportion to, the time interval between the key frames if the sound data are reproduced synchronously in reproducing a motion picture. As an alternative or in addition to the above, the imprinting unit may imprint timing data for reproducing the key frames and/or sound data into one or more of the key frames in addition to the sound data.

Still another embodiment of the present invention relates to an image processing apparatus, and more particularly relates to an image decoding apparatus. The image decoding apparatus comprises an image input unit which acquires images and an extracting unit which extracts data, which has previously been imprinted in the images, from the images, wherein the data is to be utilized together with the images. In a particular case, the extracting unit may extract sound data from the images and the apparatus may further comprise a reproduction unit which reproduces the images as a motion picture and also reproduces the sound data synchronously with the motion picture. In another case, the extracted data may include information of corresponding points which is utilized in interpolating the images, and the reproduction unit may reproduce the motion picture based on the interpolation.

Yet another embodiment of the present invention also relates to an image processing apparatus. The apparatus comprises an image input unit which acquires key frames and information of corresponding points between the key frames, an extracting unit which extracts sound data, which has previously been imprinted into the key frames, from the key frames, an intermediate image generator which generates at least oneintermediate image (or frame) between the key frames by interpolation based on the key frames and the information of the corresponding points, a sound decoding unit which decodes the extracted sound data and a display controller which outputs a motion picture that is generated from the key frames and the intermediate frames synchronously with the decoded sound data. In this embodiment, a combination of the sound decoding unit and the display controller may be called a “reproduction unit”. In a particular case, the extracting unit may extract the information of the corresponding points in addition to the sound data if the information of the corresponding points has been previously imprinted into at least one key frame.

In a particular case, the intermediate image generator may receive or acquire an instruction regarding a number of intermediate frames to be generated and may generate the intermediate frames in accordance with the instruction. In particular, a user may specify the number of intermediate frames to be generated directly, by, for example, input of a specific number, or indirectly, by, for example, inputting indications such as “fast forward” (fewer intermediate images) or “slow motion” (more intermediate images).

In the above, the reproduction unit will generally also control the synchronism of the sound data and the motion picture based on the number of intermediate frames generated. As an example, if the number of intermediate frames is doubled, the time for reproduction of the motion picture may be considered to double if the frame rate is maintained. In such a case, the sound data can be slowly reproduced over twice as long a time as original intended or, alternatively, the sound data can be reproduced at the normal speed but then temporarily stopped when waiting for a subsequent key frame or scene change or the like. In a particular case, known technology may be utilized so that the frequency of the sound reproduced would not be lowered when reproducing the sound data slowly.

As described above, the technique for generating the correspondence information (corresponding point file) may use the image matching technique described below as “base technology” however, this is not a necessary part of the embodiments.

It is to be noted that it is also possible to have replacement or substitution of the above-described structural components and elements of methods in part or whole as between method and apparatus or to add elements to either method or apparatus and also, the apparatuses and methods may be implemented by a computer program and saved on a recording medium or the like and are all effective as and encompassed by the present invention.

Moreover, this summary of the invention includes features that may not be necessary features such that an embodiment of the present invention may also be a sub-combination of these described features.

### BRIEF DESCRIPTION OF THE DRAWINGS

FIG. 1(a) is an image obtained as a result of the application of an averaging filter to a human facial image.

FIG. 1(b) is an image obtained as a result of the application of an averaging filter to another human facial image.

FIG. 1(c) is an image of a human face at p^{(5,0)} obtained in a preferred embodiment in the base technology.

FIG. 1(d) is another image of a human face at p^{(5,0)} obtained in a preferred embodiment in the base technology.

FIG. 1(e) is an image of a human face at p^{(5,1)} obtained in a preferred embodiment in the base technology.

FIG. 1(f) is another image of a human face at p^{(5,1)} obtained in a preferred embodiment in the base technology.

FIG. 1(g) is an image of a human face at p(5,2) obtained in a preferred embodiment in the base technology.

FIG. 1(h) is another image of a human face at p^{(5,2)} obtained in a preferred embodiment in the base technology.

FIG. 1(i) is an image of a human face at p^{(5,3)} obtained in a preferred embodiment in the base technology.

FIG. 1(j) is another image of a human face at p^{(5,3)} obtained in a preferred embodiment in the base technology.

FIG. 2(R) shows an original quadrilateral.

FIG. 2(A) shows an inherited quadrilateral.

FIG. 2(B) shows an inherited quadrilateral.

FIG. 2(C) shows an inherited quadrilateral.

FIG. 2(D) shows an inherited quadrilateral.

FIG. 2(E) shows an inherited quadrilateral.

FIG. 3 is a diagram showing the relationship between a source image and a destination image and that between the m-th level and the (m−1)th level, using a quadrilateral.

FIG. 4 shows the relationship between a parameters (represented by x-axis) and energy C_{f} (represented by y-axis) FIG. 5(a) is a diagram illustrating determination of whether or not the mapping for a certain point satisfies the bijectivity condition through the outer product computation.

FIG. 5(b) is a diagram illustrating determination of whether or not the mapping for a certain point satisfies the bijectivity condition through the outer product computation.

FIG. 6 is a flowchart of the entire procedure of a preferred embodiment in the base technology.

FIG. 7 is a flowchart showing the details of the process at S1 in FIG. 6.

FIG. 8 is a flowchart showing the details of the process at S10 in FIG. 7.

FIG. 9 is a diagram showing correspondence between partial images of the m-th and (m−1)th levels of resolution.

FIG. 10 is a diagram showing source images generated in the embodiment in the base technology.

FIG. 11 is a flowchart of a preparation procedure for S2 in FIG. 6.

FIG. 12 is a flowchart showing the details of the process at S2 in FIG. 6.

FIG. 13 is a diagram showing the way a submapping is determined at the 0-th level.

FIG. 14 is a diagram showing the way a submapping is determined at the first level.

FIG. 15 is a flowchart showing the details of the process at S21 in FIG. 6.

FIG. 16 is a graph showing the behavior of energy C_{f}^{(m,s)} corresponding to f^{(m's)}(λ=iΔλ) which has been obtained for a certain f^{(m,s)} while changing λ.

FIG. 17 is a diagram showing the behavior of energy C_{f}⁽ⁿ⁾ corresponding to f⁽ⁿ⁾(η=iΔη)(i=0,1, . . .) which has been obtained while changing η.

FIG. 18 is a flowchart showing a procedure by which a submapping is obtained at the m-th level in an improved base technology.

FIG. 19 shows how certain pixels correspond between a first image and a second image.

FIG. 20 shows a correspondence relation between a source polygon taken on the first image and a destination polygon taken on the second image.

FIG. 21 shows a procedure for obtaining points in the destination polygon that correspond to points in the source polygon.

FIG. 22 is a flowchart showing a procedure for generating and imprinting a corresponding point file and sound data according to an embodiment of the invention.

FIG. 23 is a flowchart showing a procedure for generating an intermediate image by extracting the corresponding point file and the sound data according to an embodiment of the invention.

FIG. 24 shows an image processing apparatus according to an embodiment of the invention.

### DETAILED DESCRIPTION OF THE INVENTION

The invention will now be described based on the preferred embodiments, which are not intended to limit the scope of, but rather, exemplify, the present invention. All of the features and the combinations thereof described in the embodiments are not necessarily essential to the invention.

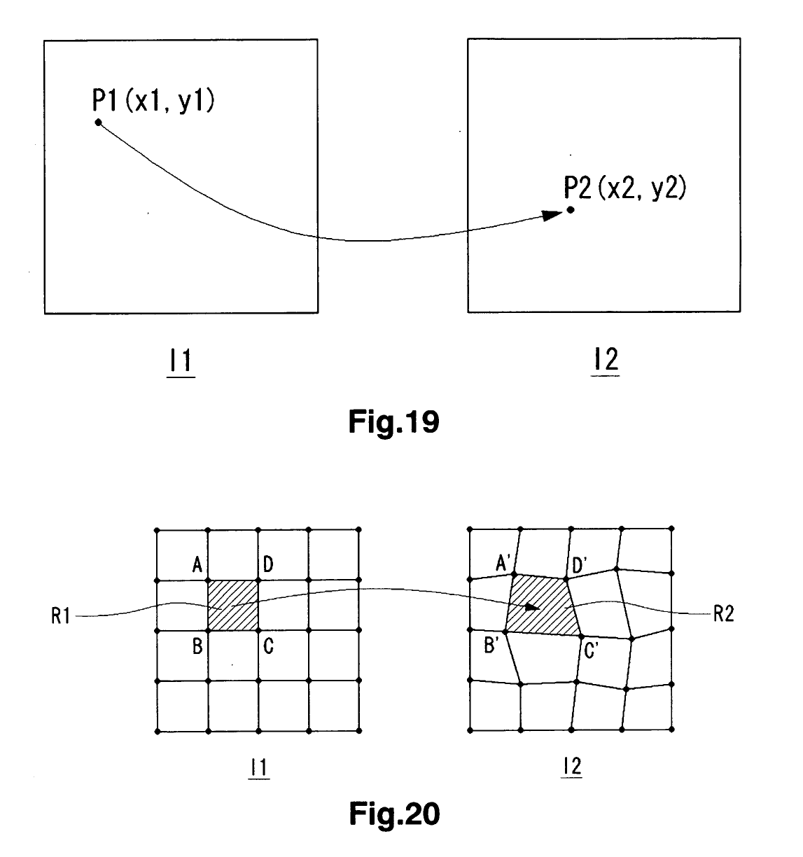

First, the multiresolutional critical point filter technology and the image matching processing using the technology, both of which will be utilized in the preferred embodiments, will bedescribed in detail as “Base Technology”. However, it is to be noted that the image matching techniques provided in the present embodiments are not limited to these base techniques. More particularly, the sections [1] and [2] (below) belong to the base technology, where section [1] describes elemental techniques and section [2] describes a processing procedure. These techniques are patented under Japanese Patent No. 2927350, and U.S. Pat. Nos. 6,018,592 and 6,137,910, owned by the same assignee of the present invention, the contents of which are hereby incorporated herein by reference. Section [3] describes various possible improvements in the base technology. Thereafter, in relation to FIGS. 19 to 24, image processing and data coding and decoding techniques, utilizing, in part, the base technology, will be described in more detail.

Base Technology

[1] Detailed Description of Elemental Techniques

[1.1] Introduction

Using a set of new multiresolutional filters called critical point filters, image matching is accurately computed. There is no need for any prior knowledge concerning the content of the images or objects in question. The matching of the images is computed at each resolution while proceeding through the resolution hierarchy. The resolution hierarchy proceeds from a coarse level to a fine level. Parameters necessary for the computation are set completely automatically by dynamical computation analogous to human visual systems. Thus, There is no need to manually specify the correspondence of points between the images.

The base technology can be applied to, for instance, completely automated morphing, object recognition, stereo photogrammetry, volume rendering, and smooth generation of motion images from a small number of frames. When applied to morphing., given images can be automatically transformed. When applied to volume rendering, intermediate images between cross sections can be accurately reconstructed, even when a distance between cross sections is rather large and the cross sections vary widely in shape.

[1.2] The Hierarchy of the Critical Point Filters

The multiresolutional filters according to the base technology preserve the intensity and location of each critical point included in the images while reducing the resolution. Initially, let the width of an image to be examined be N and the height of the image be M. For simplicity, assume that N=M=2n where n is a positive integer. An interval [0, N] c R is denoted by I. A pixel of the image at position (i, j) is denoted by p^{(i,j)} where i,jεI.

Here, a multiresolutional hierarchy is introduced. Hierarchized image groups are produced by a multiresolutional filter. The multiresolutional filter carries out a two dimensional search on an original image and detects critical points therefrom. The multiresolutinal filter then extracts the critical points from the original image to construct another image having a lower resolution. Here, the size of each of the respective images of the m-th level is denoted as 2^{m}×2^{m} (0≦m≦n). A critical point filter constructs the following four new hierarchical images recursively, in the direction descending from n.

p_{(i,j)}^{(m,0)}=min(min(p_{(2i,2j)}^{(m+1.0)},p_{(2i,2j+1)}^{(m+1.0)}),min(p_{2i+1.2j)}^{(m+1.0)},p_{(2i+1.2j+1)}^{(m+1.0)}))

p_{(i,j)}^{m,1)}=max(min(p_{(2i,2j)}^{(m+1.1)},p_{(2i,2j+1)}^{(m+1.1)}), min(p_{(2i+1.2j)}^{(m+1.1)},p_{(2i+1.2j+1)}^{(m+1.1)}))

p_{(i,j)}^{(m,2)}=min(max(p_{2i,2j)}^{m+1.2)}, p_{(2i,2j+1)}^{(m+1.2)}),max(p_{(2i+1.2j)}^{m+1.2)}, p_{2i,1.2j+1)}^{m+1.2)}))

p_{(i,j)}^{m,3)}=max(max(p_{(2i,2j)}^{m+1.3)}, p_{(2i.2j+1)}^{(m+1.3)}),max(p_{(2i+1,2j)}^{(m+1.3)}, p_{(2i+1,2j+}1)^{(m+1.3)})) (1)

where we let

p_{(i,j)}^{(n,0)}=p_{i,j}^{(n,1)}=p_{(i,j)}^{n,2)}=p_{(i,j)}^{n,3)}=p_{i,j)} (2)

The above four images are referred to as subimages hereinafter. When min_{x≦t≦x+1} and max_{x≦t≦x+}1 are abbreviated to a and β, respectively, the subimages can be expressed as follows:

p^{(m,0)}=α(x)α(y)p^{(m+1,0)}

P^{(m,1)}=α(x)β(y)p^{(m+1,1)}

p^{(m,2)}=β(x)α(y)p^{(m+1,2)}

p^{(m,2)}=β(x)β(y)p^{(m+1,3)}

Namely, they can be considered analogous to the tensor products of α and β. The subimages correspond to the respective critical points. As is apparent from the above equations, the critical point filter detects a critical point of the original image for every block consisting of 2×2 pixels. In this detection, a point having a maximum pixel value and a point having a minimum pixel value are searched with respect to two directions, namely, vertical and horizontal directions, in each block. Although pixel intensity is used as a pixel value in this base technology, various other values relating to the image may be used. A pixel having the maximum pixel values for the two directions, one having minimum pixel values for the two directions, and one having a minimum pixel value for one direction and a maximum pixel value for the other direction are detected as a local maximum point, a local minimum point, and a saddle point, respectively.

By using the critical point filter, an image (1 pixel here) of a critical point detected inside each of the respective blocks serves to represent its block image (4 pixels here) in the next lower resolution level. Thus, the resolution of the image is reduced. From a singularity theoretical point of view, α(x)α(y) preserves the local minimum,point (minima point),β(x)β(y) preserves the local maximum point (maxima point), α(x)β(y) andβ(x)α(y) preserve the saddle points.

At the beginning, a critical point filtering process is applied separately to a source image and a destination image which are to be matching-computed. Thus, a series of image groups, namely, source hierarchical images and destination hierarchical images are generated. Four source hierarchical images and four destination hierarchical images are generated corresponding to the types of the critical points.

Thereafter, the source hierarchical images and the destination hierarchical images are matched in a series of resolution levels., First, the minima points are matched using p^{(m,0)}, Next, the first saddle points are matched using p^{(m,1)} based on the previous matching result for the minima points. The second saddle points are matched using p^{(m,2)}. Finally, the maxima points are matched using p^{(m,3)}.

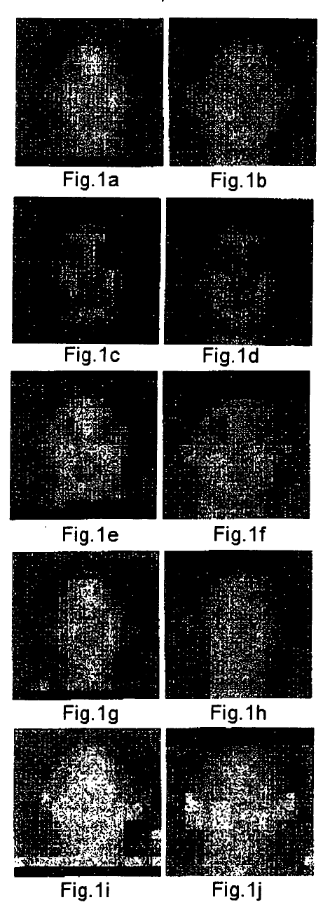

FIGS. 1c and 1d show the subimages p^{(5,0)} of the images in FIGS. 1a and 1b, respectively. Similarly, FIGS. 1e and 1f show the subimages p^{(5,1)}, FIGS. 1g and 1h show the subimages p^{(5,2)} and FIGS. 1i and 1j show the subimages p(5,3). Characteristic parts in the images can be easily matched using subimages. The eyes can be matched by p_{(5,0)} since the eyes are the minima points of pixel intensity in a face. The mouths can be matched by p^{(5,1)} since the mouths have low intensity in the horizontal direction. Vertical lines on both sides of the necks become clear by p^{(5,2)}. The ears and bright parts of the cheeks become clear by p^{(5,3)} since these are the maxima points of pixel intensity.

As described above, the characteristics of an image can be extracted by the critical point filter. Thus, by comparing, for example, the characteristics of an image shot by a camera with the characteristics of several objects recorded in advance, an object shot by the camera can be identified.

[1.3] Computation of Mapping Between Images

Now, for matching images, a pixel of the source image at the location (i,j) is denoted by p_{(i,j)}⁽ⁿ⁾ and that of the destination image at (k,l) is denoted by q_{(k,l)}⁽ⁿ⁾ where i, j, k, l εI. The energy of the mapping between the images (described later in more detail) is then defined. This energy is determined by the difference in the intensity of the pixel of the source image and its corresponding pixel of the destination image and the smoothness of the mapping. First, the mapping f^{(m,0)}:p^{(m,0)}→q^{(m,0)} between p^{(m,0)}and q^{(m,0)} with the minimum energy is computed. Based on f^{(m,0)}, the mapping f^{(m,1)} between p^{(m,1)} and q^{(m,1)} with the minimum energy is computed. This process continues until f^{(m,3)} between p^{(m,3)} and q^{(m,3)} is computed. Each f^{(m,i)} (i=0,1,2, . . . ) is referred to as a submapping. The order of i will be rearranged as shown in the following equation (3) in computing f^{(m,i)} for reasons to be described later.

f^{(m,i)}:p^{(m,σ}→q^{(m,σ(l))} (3)

where σ(i)∈{0,1,2,3}.

[1. 3. 1] Bijectivity

When the matching between a source image and a destination image is expressed by means of a mapping, that mapping shall satisfy the Bijectivity Conditions (BC) between the two images (note that a one-to-one surjective mapping is called a bijection). This is because the respective images should be connected satisfying both surjection and injection, and there is no conceptual supremacy existing between these images. It is to be noted that the mappings to be constructed here are the digital version of the bijection. In the base technology, a pixel is specified by a co-ordinate point.

The mapping of the source subimage (a subimage of a source image) to the destination subimage (a subimage of a destination image) is represented by f^{(m,s)}: I/2^{n-m}X I/2^{n-m}→I/2^{n-m}X I/2^{n-m} (s=0,1, . . . ), where f_{(i,j)}^{(m,s)}=(k,l) means that p_{(i,j)}^{(m,s) of the source image is mapped to q}_{(k,l)}^{(m,s)} of the destination image. For simplicity, when f(i,j)=(k,l) holds, a pixel q_{(k,l)} is denoted by q_{f(i,j)}.

When the data sets are discrete as image pixels (grid points) treated in the base technology, the definition of bijectivity is important. Here, the bijection will be defined in the following manner, where i, j, k and l are all integers. First, a square region R defined on the source image plane is considered

$${p}_{( i , j )}^{( m , s )} {p}_{( i + 1 , j )}^{( m , s )} {p}_{( i + 1 , j + 1 )}^{( m , s )} {p}_{( i , j + 1 )}^{( m , s )} \qquad ( 4 )$$

where i=0, . . . , 2^{m}−1, and j=0, . . . , 2^{m}−1. The edges of R are directed as follows:

$$\overline{{p}_{( i , j )}^{( m , s )} {p}_{( i + 1 , j )}^{( m , s )}} , \overline{{p}_{( i + 1 , j )}^{( m , s )} {p}_{( i + 1 , j + 1 )}^{( m , s )}} , \overline{{p}_{( i + 1 , j + 1 )}^{( m , s )} {p}_{( i , j + 1 )}^{( m , s )}} \text{and} \overline{{p}_{( i , j + 1 )}^{( m , s )} {p}_{( i , j )}^{( m , s )}} \qquad ( 5 )$$

This square region R will be mapped by f to a quadrilateral on the destination image plane:

$${q}_{f ( i , j )}^{( m , s )} {q}_{f ( i + 1 , j )}^{( m , s )} {q}_{f ( i + 1 , j + 1 )}^{( m , s )} {q}_{f ( i , j + 1 )}^{( m , s )} \qquad ( 6 )$$

This mapping f^{(m,s)}(R), that is,

$${f}^{( m , s )} ( R ) = {f}^{( m , s )} ( {p}_{( i , j )}^{( m , s )} {p}_{( i + 1 , j )}^{( m , s )} {p}_{( i + 1 , j + 1 )}^{( m , s )} {p}_{( i , j + 1 )}^{( m , s )} ) = {q}_{f ( i , j )}^{( m , s )} {q}_{f ( i + 1 , j )}^{( m , s )} {q}_{f ( i + 1 , j + 1 )}^{( m , s )} {q}_{f ( i , j + 1 )}^{( m , s )} )$$

should satisfy the following bijectivity conditions(referred to as BC hereinafter):

1. The edges of the quadrilateral f^{(m,s)}(R) should not intersect one another.

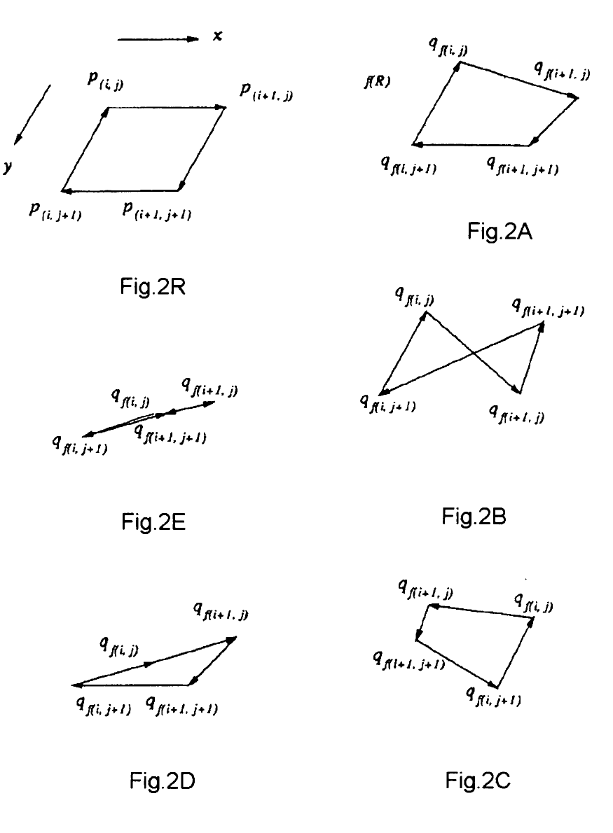

2. The orientation of the edges of f^{(m,s)}(R) should be the same as that of R (clockwise in the case shown in FIG. 2, described below).

3. As a relaxed condition, a retraction mapping is allowed.

Without a certain type of a relaxed condition as in, for example, condition 3 above, there would be no mappings which completely satisfy the BC other than a trivial identity mapping. Here, the length of a single edge of f^{(m,s)}(R) may be zero. Namely, f^{(m,s)}(R) may be a triangle. However, f^{(m,s)}(R) is not allowed to be a point or a line segment having area zero. Specifically speaking, if FIG. 2R is the original quadrilateral, FIGS. 2A and 2D satisfy the BC while FIGS. 2B, 2C and 2E do not satisfy the BC.

In actual implementation, the following condition may be further imposed to easily guarantee that the mapping is surjective. Namely, each pixel on the boundary of the source image is mapped to the pixel that occupies the same location at the destination image. In other words, f(i,j)=(i,j) (on the four lines of i=0, i=2^{m}−1, j=0, j=2^{m}−1). This condition will be hereinafter referred to as an additional condition.

[1. 3. 2] Energy of mapping

[1. 3. 2. 1] Cost related to the pixel intensity

The energy of the mapping f is defined. An objective here is to search a mapping whose energy becomes minimum. The energy is determined mainly by the difference in the intensity between the pixel of the source image and its corresponding pixel of the destination image. Namely, the energy c_{i,j)}^{(m,s)}of the mapping f^{(m,s)} at(i,j) is determined by the following equation (7).

C_{i,j)}^{(m,s)}32 |V(p_{(i,j)}^{(m,s)})−V(q_{f(i,j)}^{(m,s)})|² (7)

where V(p_{(i,j)}^{(m,s)} and V(q_{f(i,j)}^{(m,s)}) are the intensity values of the pixels p_{(i,f)}^{(m,s)} and q_{f(i,j)}^{(m,s)}, respectively. The total energy C^{(m,s)} of f is a matching evaluation equation, and can be defined as the sum of C_{(i,j)}^{(m,s) as shown in the following equation (}8).

$${C}_{f}^{( m , s )} = {\sum }_{i = 0}^{i = {2}^{m} - 1} {\sum }_{j = 0}^{j = {2}^{m} - 1} {C}_{( i , j )}^{( m , s )} \qquad ( 8 )$$

[1. 3. 2. 2] Cost Related to the Locations of the Pixel for Smooth Mapping

In order to obtain smooth mappings, another energy D_{f} for the mapping is introduced. The energy D_{f} is determined by the locations of p_{(i,j)}^{(m,s)} and q_{f(i,j)}^{(m,s)} (i=0,1, . . . ,2^{m}−1, j=0,1, . . . ,2^{m}−1), regardless of the intensity of the pixels. The energy D_{(i,j)}^{(m,s)} of the mapping f^{(m,s)} at a point (i,j) is determined by the following equation (9).

D_{(i,j)}^{(m,s)}=ηE_{0(i,j)}^{(m,s)}+E_{1(i,j)}^{(m,s)} (9)

where the coefficient parameter l which is equal to or greater than 0 is a real number. And we have

E_{0(i,j)}^{(m,s)}=∥(i,j)−f^{(m,s)}(i,j)∥² (10)

$${E}_{1 ( i , j )}^{( m , s )} = {\sum }_{{i}^{′} = i - 1}^{i} {\sum }_{{j}^{′} = j - 1}^{j} {‖ ( {f}^{( m , s )} ( i , j ) - ( i , j ) ) - ( {f}^{( m , s )} ( {i}^{′} , {j}^{′} ) - ( {i}^{′} , {j}^{′} ) ) ‖}^{2} / 4 \qquad ( 11 )$$

where

∥(x,y)∥=√x²+y² (12),

i′ and j′ are integers and f(i′,j′) is defined to be zero for i′<0 and j′<0. E₀ is determined by the distance between (i,j) and f(i,j). Eoprevents a pixel from being mapped to a pixel too far away from it. However, as explained below, E₀ can be replaced by another energy function. E₁ ensures the smoothness of the mapping. E₁ represents a distance between the displacement of p(i,j) and the displacement of its neighboring points. Based on the above consideration, another evaluation equation for evaluating the matching, or the energy D_{f} is determined by the following equation:

$${D}_{f}^{( m , s )} = {\sum }_{i = 0}^{i = {2}^{m} - 1} {\sum }_{j = 0}^{j = {2}^{m} - 1} {D}_{( i , j )}^{( m , s )} \qquad ( 13 )$$

[1. 3. 2. 3] Total Energy of the Mapping

The total energy of the mapping, that is, a combined evaluation equation which relates to the combination of a plurality of evaluations, is defined as λC_{f}^{(m,s)}+D_{f}^{(m,s)}, where λ≧0 is a real number. The goal is to detect a state in which the combined evaluation equation has an extreme value, namely, to find a mapping which gives the minimum energy expressed by the following:

$${min}_{f} \{ λ {C}_{f}^{( m , s )} + {D}_{f}^{( m , s )} \} \qquad ( 14 )$$

Care must be exercised in that the mapping becomes an identity mapping if X=0 and η=0 (i.e., f^{(m,s)}(i,j)=(i,j) for all i=0,1, . . . ,2^{m}−1 and j=0,1, . . . ,2m−1). As will be described later, the mapping can be gradually modified or transformed from an identity mapping since the case of λ=0 and η=0 is evaluated at the outset in the base technology. If the combined evaluation equation is defined as C_{f}^{(m,s)}+λD_{f}^{(m,s)} where the original position of λ is changed as such, the equation with λ=0 and η32 0 will be C_{f}^{(m,s)} only. As a result thereof, pixels would randomly matched to each other only because their pixel intensities are close, thus making the mapping totally meaningless. Transforming the mapping based on such a meaningless mapping makes no sense. Thus, the coefficient parameter is so determined that the identity mapping is initially selected for the evaluation as the best mapping.

Similar to this base technology, differences in the pixel intensity and smoothness are considered in a technique called “optical flow” that is known in the art. However, the optical flow technique cannot be used for image transformation since the optical flow technique takes into account only the local movement of an object. However, global correspondence can also be detected by utilizing the critical point filter according to the base technology.

[1. 3. 3] Determining the Mapping with Multiresolution

A mapping fₘᵢₙ which gives the minimum energy and satisfies the BC is searched by using the multiresolution hierarchy. The mapping between the source subimage and the destination subimage at each level of the resolution is computed. Starting from the top of the resolution hierarchy (i.e., the coarsest level), the mapping is determined at each resolution level, and where possible, mappings at other levels are considered. The number of candidate mappings at each level is restricted by using the mappings at an upper (i.e., coarser) level of the hierarchy. More specifically speaking, in the course of determining a mapping at a certain level, the mapping obtained at the coarser level by one is imposed as a sort of constraint condition.

We thus define a parent and child relationship between resolution levels. When the following equation (15) holds,

$$( {i}^{′} , {j}^{′} ) = ( ⌊ \frac{i}{2} ⌋ , ⌊ \frac{j}{2} ⌋ ) , \qquad ( 15 )$$

where └x┘ denotes the largest integer not exceeding x, p_{(i′,j′)}^{(m-1,s)} and q_{(i′,j′)}^{(m-1,s)} are respectively called the parents of p_{(i,j)}^{(m,s) and q}_{(i,j)}^{(m,s)},. Conversely, p_{(i,j)}^{(m,s)} and q_{(i,j)}^{(m,s)} are the child of p_{(i,j)}^{(m,s)} and the child of q_{(i′,j′)}^{(m-1,s)}, respectively. A function parent(i,j) is defined by the following equation (16):

$$p a r e n t ( i , j ) = ( ⌊ \frac{i}{2} ⌋ , ⌊ \frac{j}{2} ⌋ ) \qquad ( 16 )$$

Now, a mapping between p_{(i,j)}^{(m,s)} and q_{(k,l)}^{(m,s)} is determined by computing the energy and finding the minimum thereof. The value of f^{(m,s)}(i,j)=(k,l) is determined as follows using f(m−1,s) (m=1,2, . . .,n). First of all, a condition is imposed that q_{(k,l)}^{(m,s)} should lie inside a quadrilateral defined by the following definitions (17) and (18). Then, the applicable mappings are narrowed down by selecting ones that are thought to be reasonable or natural among them satisfying the BC.

q_{g}_{^{(m,s)}}_{i-1,j-1)}^{(m,s)}q_{g}_{^{(m,s)}}_{(i-1 1,j-1)}^{(m,s)}q_{g}_{^{(m,s)}}_{(i+1,j+1)}^{(m,s)}q_{g}_{^{(m,s)}}_{(i+1,j-1)}^{(m,s)} (17)

where

g^{(m,s)}(i,j)=f^{(m-1,s)}(parent(i,j,))+f^{(m-1,s)}(parent(i,j)+(1,1)) (18)

The quadrilateral defined above is hereinafter referred to as the inherited quadrilateral of p_{(i,j)}^{(m,s)}. The pixel minimizing the energy is sought and obtained inside the inherited quadrilateral.

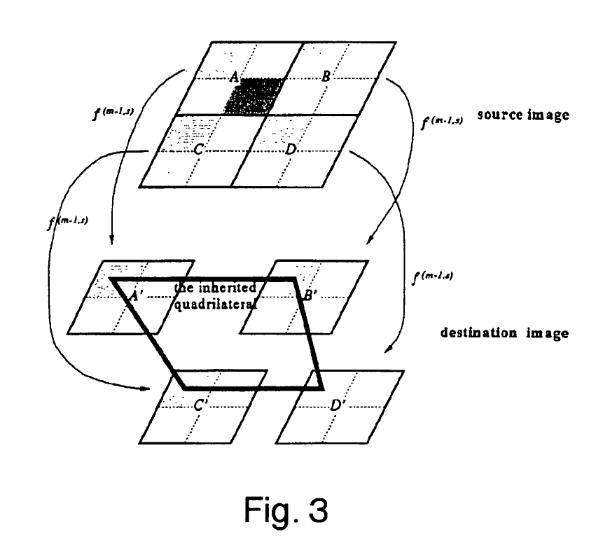

FIG. 3 illustrates the above-described procedures. The pixels A, B, C and D of the source image are mapped to A′, B′, C′ and D′ of the destination image, respectively, at the (m−1)th level in the hierarchy. The pixel p_{(i,j)}^{(m,s)} should be mapped to the pixel q_{f}_{^{(m)}}_{(i,j)}^{(m,s)} which exists inside the inherited quadrilateral A′B′C′D′. Thereby, bridging from the mapping at the (m−1)th level to the mapping at the m-th level is achieved.

The energy E₀ defined above may now be replaced by the following equations (19) and (20):

E_{0(i,j)}=∥f^{(m,0)}(i,j)−g^{(m)}(i,j)∥² (19)

E_{0(i,j)}−∥f^{(m,s)}(i,j)−f^{(m,s-1)}(i,j)∥²,(1≦i) (20)

for computing the submapping f^{(m,0)} and the submapping f^{(m,s)} at the m-th level, respectively.

In this manner, a mapping which maintains a low energy of all the submappings is obtained. Using the equation (20) makes the submappings corresponding to the different critical points associated to each other within the same level in order that the subimages can have high similarity. The equation (19) represents the distance between f^{(m,s)}(i,j) and the location where (i,j) should be mapped when regarded as a part of a pixel at the (m−1)the level.

When there is no pixel satisfying the BC inside the inherited quadrilateral A′B′C′D′, the following steps are taken. First, pixels whose distance from the boundary of A′B′C′D′ is L (at first, L=1) are examined. If a pixel whose energy is the minimum among them satisfies the BC, then this pixel will be selected as a value of f^{(m,s)}(i,j). L is increased until such a pixel is found or L reaches its upper bound Lₘₐₓ^{(m)}. Lₘₐₓ^{(m)} is fixed for each level m. If no pixel is found at all, the third condition of the BC is ignored temporarily and such mappings that caused the area of the transformed quadrilateral to become zero (a point or a line) will be permitted so as to determine f^{(m,s)}(i,j) If such a pixel is still not found, then the first and the second conditions of the BC will be removed.

Multiresolution approximation is essential to determining the global correspondence of the images while preventing the mapping from being affected by small details of the images. Without the multiresolution approximation, it is impossible to detect a correspondence between pixels whose distances are large. In the case where the multiresolution approximation is not available, the size of an image will generally be limited to a very small size, and only tiny changes in the images can be handled. Moreover, imposing smoothness on the mapping usually makes it difficult to find the correspondence of such pixels. That is because the energy of the mapping from one pixel to another pixel which is far therefrom is high. On the other hand, the multiresolution approximation enables finding the approximate correspondence of such pixels. This is because the distance between the pixels is small at the upper (coarser) level of the hierarchy of the resolution.

[1. 4] Automatic Determination of the Optimal Parameter Values

One of the main deficiencies of the existing image matching techniques lies in the difficulty of parameter adjustment. In most cases, the parameter adjustment is performed manually and it is extremely difficult to select the optimal value. However, according to the base technology, the optimal parameter values can be obtained completely automatically.

The systems according to this base technology include two parameters, namely, λ and η, where λ and η represent the weight of the difference of the pixel intensity and the stiffness of the mapping, respectively. In order to automatically determine these parameters, the are initially set to 0. First, λ is gradually increased from λ=0 while η is fixed at 0. As λ becomes larger and the value of the combined evaluation equation (equation (14)) is minimized, the value of C_{f}^{(m,s)} for each submapping generally becomes smaller. This basically means that the two images are matched better. However, if λ exceeds the optimal value, the following phenomena occur:

1. Pixels which should not be corresponded are erroneously corresponded only because their intensities are close.

2. As a result, correspondence between images becomes inaccurate, and the mapping becomes invalid.

3. As a result, D_{f}^{(m,s)} in equation (14) tends to increase abruptly.

4. As a result, since the value of equation (14) tends to increase abruptly, f^{(m,s)} changes in order to suppress the abrupt increase of D_{f}^{(m,s)}. As a result, C_{f}^{(m,s)} increases.

Therefore, a threshold value at which C_{f}^{(m,s)} turns to an increase from a decrease is detected while a state in which equation (14) takes the minimum value with λ being increased is kept. Such λ is determined as the optimal value at η=0. Next, the behavior of C_{f}^{(m,s)} is examined while η is increased gradually, and η will be automatically determined by a method described later. λ will then again be determined corresponding to such an automatically determined η.

The above-described method resembles the focusing mechanism of human visual systems. In the human visual systems, the images of the respective right eye and left eye are matched while moving one eye. When the objects are clearly recognized, the moving eye is fixed.

[1. 4. 1] Dynamic Determination of λ

Initially, λ is increased from 0 at a certain interval, and a subimage is evaluated each time the value of k changes. As shown in equation (14), the total energy is defined by λC_{f}^{(m,s)+D}_{f}^{(m,s)}+D_{f}^{(m,s)}. D_{(i,j)}^{(m,s)} in equation (9) represents the smoothness and theoretically becomes minimum when it is the identity mapping. E₀ and E₁ increase as the mapping is further distorted. Since E₁ is an integer, 1 is the smallest step of D_{f}^{(m,s)}. Thus, it is impossible to change the mapping to reduce the total energy unless a changed amount (reduction amount) of the current λC_{(i,j)}^{(m,s)} is equal to or greater than 1. Since D_{f}^{(m,s)} increases by more than 1 accompanied by the change of the mapping, the total energy is not reduced unless λC_{(i,j)}^{(m,s)} is reduced by more than 1.

Under this condition, it is shown that C_{(i,j)}^{(m,s)} decreases in normal cases as λ increases. The histogram of C_{(i,j)}^{(m,s)} is denoted as h(1), where h(1) is the number of pixels whose energy C_{(i,j)}^{(m,s)} is 1². In order that λ1²≧1 for example, the case of 1²=1/λ is considered. When λ varies from λ₁ to λ₂, a number of pixels (denoted A) expressed by the following equation (21):

$$A = {{\sum }^{⌊ \frac{1}{{λ}_{1}} ⌋}}_{l = ⌈ \frac{1}{{λ}_{2}} ⌉} h ( l ) ≅ {\int }_{l = \frac{1}{{λ}_{2}}}^{\frac{1}{{λ}_{1}}} h ( l ) ⅆ l = - {\int }_{{λ}_{2}}^{{λ}_{1}} h ( l ) \frac{1}{{λ}^{3 / 2}} ⅆ λ = {\int }_{{λ}_{1}}^{{λ}_{2}} \frac{h ( l )}{{λ}^{3 / 2}} ⅆ λ \qquad ( 21 )$$

changes to a more stable state having the energy shown in equation(22):

$${C}_{f}^{( m , s )} - {l}^{2} = {C}_{f}^{( m , s )} - \frac{1}{λ} . \qquad ( 22 )$$

Here, it is assumed that the energy of these pixels is approximated to be zero. This means that the value of C_{(i,j)}^{(m,s)} changes by:

$$\partial {C}_{f}^{( m , s )} = - \frac{A}{λ} \qquad ( 23 )$$

As a result, equation (24) holds.

$$\frac{\partial {C}_{f}^{( m , s )}}{\partial λ} = - \frac{h ( l )}{{λ}^{5 / 2}} \qquad ( 24 )$$

Since h(1)>0, C_{f}^{(ms)} decreases in the normal case. However, when λ exceeds the optimal value, the above phenomenon, that is, an increase in c_{f}^{(m,s)} occurs. The optimal value of λ is determined by detecting this phenomenon.

When

$$h ( l ) = H {l}^{k} = \frac{H}{{λ}^{k / 2}} \qquad ( 25 )$$

is assumed, where both H(H>0) and k are constants, the equation (26) holds:

$$\frac{\partial {C}_{f}^{( m , s )}}{\partial λ} = - \frac{H}{{λ}^{5 / 2 + k / 2}} \qquad ( 26 )$$

Then, if k‥−3, the following equation (27) holds:

$${C}_{f}^{( m , s )} = C + \frac{H}{( 3 / 2 + k / 2 ) {λ}^{3 / 2 + k / 2}} \qquad ( 27 )$$

The equation (27) is a general equation of C_{f}^{(m,s)} (where C is a constant).

When detecting the optimal value of λ, the number of pixels violating the BC may be examined for safety. In the course of determining a mapping for each pixel, the probability of violating the BC is assumed as a value p₀ here. In this case, since

$$\frac{\partial A}{\partial λ} = \frac{h ( l )}{{λ}^{3 / 2}} \qquad ( 28 )$$

holds, the number of pixels violating the BC increases at a rate of:

$$\begin{matrix}{B}_{0} = \frac{h ( l ) {p}_{0}}{{λ}^{3 / 2}} \\ T h u s , & ( 29 ) \\ \frac{{B}_{0} {λ}^{3 / 2}}{{p}_{0} h ( l )} = 1 & ( 30 )\end{matrix}$$

is a constant. If it is assumed that h(l)=Hl^{k}, the following equation (31), for example,

B₀λ^{3/2+k/2}=p₀H (31)

becomes a constant. However, when λ exceeds the optimal value, the above value of equation (31) increases abruptly. By detecting this phenomenon, i.e. whether or not the value of B₀λ^{3/2+k/2}/2^{m} exceeds an abnormal value B₀ₜₕᵣₑₛ, the optimal value of λ can be determined. Similarly, whether or not the value of B₁λ^{3/2+k/2}/2^{m} exceeds an abnormal value B₁ₜₕᵣₑₛ can be used to check for an increasing rate B₁ of pixels violating the third condition of the BC. The reason why the factor 2^{m} is introduced here will be described at a later stage. This system is not sensitive to the two threshold values B₀ₜₕᵣₑₛ and B₁ₜₕᵣₑₛ. The two threshold values B₀ₜₕᵣₑₛ and B₁ₜₕᵣₑₛ can be used to detect excessive distortion of the mapping which may not be detected through observation of the energy C_{f}^{(m,s)}.

In the experimentation, when λ exceeded 0.1 the computation of f^{(m,s)} was stopped and the computation of f^{(m,s+1)} was started. That is because the computation of submappings is affected by a difference of only 3 out of 255 levels in pixel intensity when λ>0.1 and it is then difficult to obtain a correct result.

[1. 4. 2] Histogram h(l)

The examination of C_{f}^{(m,s)} does not depend on the histogram h(l), however, the examination of the BC and its third condition may be affected by h(l). When (λ, C_{f}^{(m,s)}) is actually plotted, k is usually close to 1. In the experiment, k=1 is used, that is, B₀λ² and B₁λ² are examined. If the true value of k is less than 1, B₀λ² and B₁λ² are not constants and increase gradually by a factor of λ^{(1-k)/2}. If h(l) is a constant, the factor is, for example, λ^{1/2}. However, such a difference can be absorbed by setting the threshold B₀ₜₕᵣₑₛ appropriately.

Let us model the source image by a circular object, with its center at(x₀,y₀) and its radius r, given by:

$$p ( i , j ) = \{ \begin{matrix} \frac{255}{r} c ( \sqrt{{( i - {x}_{0} )}^{2} + {( j - {y}_{0} )}^{2}} ) … ( \sqrt{{( i - {x}_{0} )}^{2} + {( j - {y}_{0} )}^{2}} \leq r ) \\ 0 … ( o t h e r w i s e )\end{matrix} \qquad ( 32 )$$

and the destination image given by:

$$q ( i , j ) = \{ \begin{matrix} \frac{255}{r} c ( \sqrt{{( i - {x}_{1} )}^{2} + {( j - {y}_{1} )}^{2}} ) … ( \sqrt{{( i - {x}_{1} )}^{2} + {( j - {y}_{1} )}^{2}} \leq r ) \\ 0 … ( o t h e r w i s e )\end{matrix} \qquad ( 33 )$$

with its center at(x₁,y₁) and radius r. In the above, let c(x) have the form of c(x)=x^{k}. When the centers (x₀,y₀) and (x₁,y₁) are sufficiently far from each other, the histogram h(l) is then in the form:

h(l)∝rl^{k}(k≠0) (34)

When k=1, the images represent objects with clear boundaries embedded in the background. These objects become darker toward their centers and brighter toward their boundaries. Whenk=−1, the images represent objects with vague boundaries. These objects are brightest at their centers, and become darker toward their boundaries. Without much loss of generality, it suffices to state that objects in images are generally between these two types of objects. Thus, choosing k such that −1≦k≦1 can cover most cases and the equation (27) is generally a decreasing function for this range.

As can be observed from the above equation (34), attention must be directed to the fact that r is influenced by the resolution of the image, that is, r is proportional to 2^{m}. This is the reason for the factor 2^{m} being introduced in the above section [1.4.1].

[1. 4. 3] Dynamic Determination of η

The parameter η can also be automatically determined in a similar manner. Initially, η is set to zero, and the final mapping f⁽ⁿ⁾, and the energy C_{f}⁽ⁿ⁾ at the finest resolution are computed. Then, after η is increased by a certain value Δη, the final mapping f⁽ⁿ⁾ and the energy C_{f}⁽ⁿ⁾ at the finest resolution are again computed. This process is repeated until the optimal value of η is obtained. η represents the stiffness of the mapping because it is a weight of the following equation (35):

E_{0(i,j)}^{(m,s)}=∥f^{(m,s)}(i,j)−f^{(m,s-1)}(i,j)∥² (35)

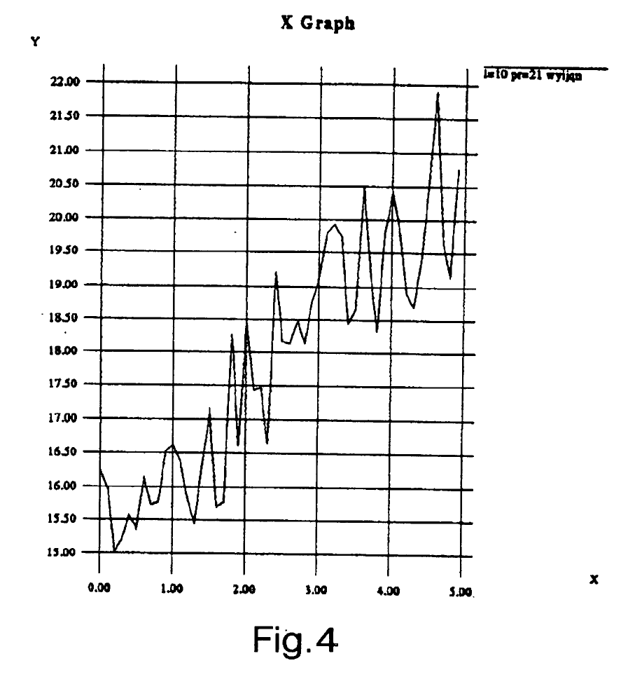

If η is zero, D_{f}⁽ⁿ⁾ is determined irrespective of the previous submapping, and the present submapping may be elastically deformed and become too distorted. On the other hand, if η is a very large value, D_{f}⁽ⁿ⁾ is almost completely determined by the immediately previous submapping. The submappings are then very stiff, and the pixels are mapped to almost the same locations. The resulting mapping is therefore the identity mapping. When the value of η increases from 0, c_{f}⁽ⁿ⁾ gradually decreases as will be described later. However, when the value of η exceeds the optimal value, the energy starts increasing as shown in FIG. 4. In FIG. 4, the x-axis represents η, and y-axis represents C_{f}.

The optimum value of η which minimizes C_{f}⁽ⁿ⁾ can be obtained in this manner. However, since various elements affect this computation as compared to the case of λ, C_{f}⁽ⁿ⁾ changes while slightly fluctuating. This difference is caused because a submapping is re-computed once in the case of λ whenever an input changes slightly, whereas all the submappings must be re-computed in the case of η. Thus, whether the obtained value of C_{f}⁽ⁿ⁾ is the minimum or not cannot be determined as easily. When candidates for the minimum value are found, the true minimum needs to be searched by setting up further finer intervals.

[1. 5] Supersampling

When deciding the correspondence between the pixels, the range of f^{(m,s)} can be expanded to R×R (R being the set of real numbers) in order to increase the degree of freedom. In this case, the intensity of the pixels of the destination image is interpolated, to provide f^{(m,s)} having an intensity at non-integer points:

V(q_{f}_{^{(m,s)}}_{(i,j)}^{(m,s)}) (36)

That is, supersampling is performed. In an example implementation, f^{(m,s)} may take integer and half integer values, and

V(q_{(i,j)+(0. 5,0.5)}^{(m,s)}) (37)

is given by

(V(q_{(i,j)}^{(m,s)})+V(q_{(i,j)+(1+1)}^{(m,s)}))/2 (38)

[1. 6] Normalization of the Pixel Intensity of Each Image

When the source and destination images contain quite different objects, the raw pixel intensity may not be used to compute the mapping because a large difference in the pixel intensity causes excessively large energy C_{f}^{(m,s)} and thus making it difficult to obtain an accurate evaluation.

For example, a matching between a human face and a cat's face is computed as shown in FIGS. 20(a) and 20(b). The cat's face is covered with hair and is a mixture of very bright pixels and very dark pixels. In this case, in order to compute the submappings of the two faces, subimages are normalized. That is, the darkest pixel intensity is set to 0 while the brightest pixel intensity is set to 255, and other pixel intensity values are obtained using linear interpolation.

[1. 7] Implementation

In an example implementation, a heuristic method is utilized wherein the computation proceeds linearly as the source image is scanned. First, the value of f^{(m,s)} is determined at the top leftmost pixel (i,j)=(0,0). The value of each f^{(m,s)}(i,j) is then determined while i is increased by one at each step. When i reaches the width of the image, j is increased by one and i is reset to zero. Thereafter, f^{(m's)}(i,j) is determined while scanning the source image. Once pixel correspondence is determined for all the points, it means that a single mapping f^{(m,s)} is determined.

When a corresponding point q_{f(i,j)} is determined for p_{(i,j)}, a corresponding point q_{f(i,j+1)} of P_{(i,j+1)} is determined next. The position of q_{f(i,j+1)} is constrained by the position of q_{f(i,j)} since the position of q_{f(i,j+1)} satisfies the BC. Thus, in this system, a point whose corresponding point is determined earlier is given higher priority. If the situation continues in which (0,0) is always given the highest priority, the final mapping might be unnecessarily biased. In order to avoid this bias, f^{(m,s)} is determined in the following manner in the base technology.

First, when (s mod 4) is 0, f^{(m,s)} is determined starting from (0,0) while gradually increasing both i and j. When (s mod 4) is 1, f^{(m,s)} is determined starting from the top rightmost location while decreasing i and increasing j. When (s mod 4) is 2, f^{(m,s)} is determined starting from the bottom rightmost location while decreasing both i and j. When (s mod 4) is 3, f^{(m,s)} is determined starting from the bottom leftmost location while increasing i and decreasing j. Since a concept such as the submapping, that is, a parameter s, does not exist in the finest n-th level, f^{(m,s)} is computed continuously in two directions on the assumption that s=0 and s=2.

In this implementation, the values of f^{(m,s)}(i,j) (m=0, . . . ,n) that satisfy the BC are chosen as much as possible from the candidates (k,l) by imposing a penalty on the candidates violating the BC. The energy D_{(k,l)} of a candidate that violates the third condition of the BC is multiplied by φ and that of a candidate that violates the first or second condition of the BC is multiplied by ψ. In this implementation, φ=2 and ψ=100000 are used.

In order to check the above-mentioned BC, the following test may be performed as the procedure when determining (k, l)=f^{(m,s)}(i,j). Namely, for each grid point (k,l) in the inherited quadrilateral of f^{(m,s)},(i,j), whether or not the z-component of the outer product of

W=\overline{A}×\overline{B} (39)

is equal to or greater than 0 is examined, where

$$\begin{matrix}\vec{A} = \overline{{q}_{{f}^{( m , s )} ( i , j - 1 )}^{( m , s )} {q}_{{f}^{( m , s )} ( i + 1 , j - 1 )}^{( m , s )}} & ( 40 ) \\ \vec{B} = \overline{{q}_{{f}^{( m , s )} ( i , j - 1 )}^{( m , s )} {q}_{( k , l )}^{( m , s )}} & ( 41 )\end{matrix}$$

Here, the vectors are regarded as 3D vectors and the z-axis is defined in the orthogonal right-hand coordinate system. When W is negative, the candidate is imposed with a penalty by multiplying D_{(k,l)}^{(m,s)} by ψ so that it is not as likely to be selected.

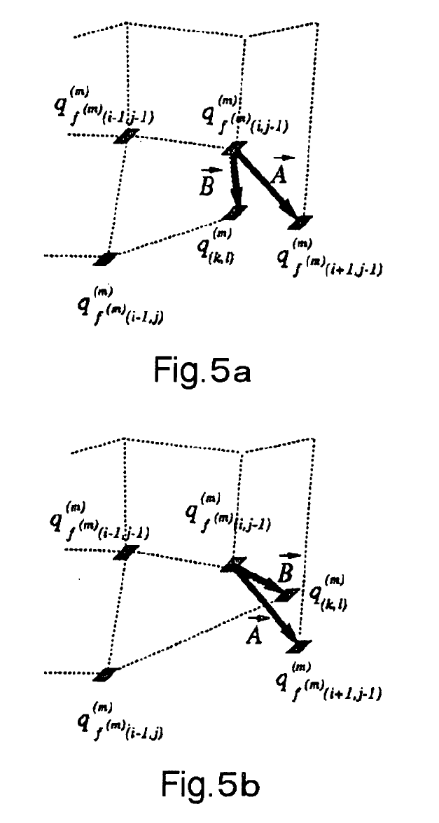

FIGS. 5(a) and 5(b) illustrate the reason why this condition is inspected. FIG. 5(a) shows a candidate without a penalty and FIG. 5(b) shows one with a penalty. When determining the mapping f^{(m,s)}(i,j+1) for the adjacent pixel at (i,j+1), there is no pixel on the source image plane that satisfies the BC if the z-component of W is negative because then q_{(k,l)}^{(m,s)} passes the boundary of the adjacent quadrilateral.

[1. 7. 1] The Order of Submappings

In this implementation, σ(0)=0, σ(1)=1, σ(2)=2, σ(3)=3, σ(4)=0 are used when the resolution level is even, while σ((0)=3, σ(1)=2, σ(2)=1, σ(3)=0, σ(4)=3 are used when the resolution level is odd. Thus, the submappings are shuffled to some extent. It is to be noted that the submappings are primarily of four types, and s may be any of 0 to 3. However, a processing with s=4 is used in this implementation for a reason to be described later.

[1. 8] Interpolations

After the mapping between the source and destination images is determined, the intensity values of the corresponding pixels are interpolated. In the implementation, trilinear interpolation is used. Suppose that a square p_{(i,j)}p_{(i+1,j)}p_{(i+1,j+1)}p_{(i,j+1)} on the source image plane is mapped to a quadrilateral q_{f(i,j)}q_{f(i+1,j)}q_{f(i+1,j)}q_{f(i,j+1}) on the destination image plane. For simplicity, the distance between the image planes is assumed to be 1. The intermediate image pixels r(x,y,t) (0 [symbol] x [symbol] N−1, 0 [symbol] y [symbol] M−1) whose distance from the source image plane is t (0 [symbol] t [symbol] 1) are obtained as follows. First, the location of the pixel r(x,y,t), where x,y,t∈R, is determined by equation (42):

$$\begin{matrix}( x , y ) = ( 1 - dx ) ( 1 - dy ) ( 1 - t ) ( i , j ) + ( 1 - dx ) ( 1 - dy ) tf ( i , j ) + \\ dx ( 1 - dy ) ( 1 - t ) ( i + 1 , j ) + dx ( 1 - dy ) tf ( i + 1 , j ) + \\ ( 1 - dx ) dy ( 1 - t ) ( i , j + 1 ) + ( 1 - dx ) dytf ( i , j + 1 ) + \\ dxdy ( 1 - t ) ( i + 1 , j + 1 ) + dxdytf ( i + 1 , j + 1 )\end{matrix} \qquad ( 42 )$$

The value of the pixel intensity at r(x,y,t) is then determined by equation (43):

$$\begin{matrix}V ( r ( x , y , t ) ) = ( 1 - dx ) ( 1 - dy ) ( 1 - t ) V ( {p}_{( i , j )} ) + ( 1 - dx ) \\ ( 1 - dy ) tV ( {q}_{f ( i , j )} ) + dx ( 1 - dy ) ( 1 - t ) \\ V ( {p}_{( i + 1 , j )} ) + dx ( 1 - dy ) tV ( {q}_{f ( i + 1 , j )} ) + ( 1 - dx ) \\ dy ( 1 - t ) V ( {p}_{( i , j + 1 )} ) + ( 1 - dx ) dytV ( {q}_{f ( i , j + 1 )} ) + \\ dxdy ( 1 - t ) V ( {p}_{( i + 1 , j + 1 )} ) + dxdytV ( {q}_{f ( i + 1 , j + 1 )} )\end{matrix} \qquad ( 43 )$$

where dx and dy are parameters varying from 0 to 1.

[1. 9] Mapping to Which Constraints are Imposed

So far, the determination of a mapping in which no constraints are imposed has been described. However, if a correspondence between particular pixels of the source and destination images is provided in a predetermined manner, the mapping can be determined using such correspondence as a constraint.

The basic idea is that the source image is roughly deformed by an approximate mapping which maps the specified pixels of the source image to the specified pixels of the destination image and thereafter a mapping f is accurately computed.

First, the specified pixels of the source image are mapped to the specified pixels of the destination image, then the approximate mapping that maps other pixels of the source image to appropriate locations are determined. In other words, the mapping is such that pixels in the vicinity of a specified pixel are mapped to locations near the position to which the specified one is mapped. Here, the approximate mapping at the m-th level in the resolution hierarchy is denoted by F^{(m)}.

The approximate mapping F is determined in the following manner. First, the mappings for several pixels are specified. When nₛ pixels

p(i₀, j₀),p(i₁, j₁), . . . , p(iₙ_{ₛ}⁻¹,jₙ_{ₛ}⁻¹) (44)

of the source image are specified, the following values in the equation (45) are determined.

F⁽ⁿ⁾(i₀,j₀)=(k₀,l₀), F⁽ⁿ⁾(i₁,j₁)=(k₁,l₁), . . ., F⁽ⁿ⁾(iₙ_{ₛ}₋₁,jₙ_{ₛ}₋₁)=(kₙ_{ₛ}₋₁,lₙ_{ₛ}₋₁) (45)

For the remaining pixels of the source image, the amount of displacement is the weighted average of the displacement of p(iₕ,jₕ) (h=0, . . . , nₛ−1). Namely, a pixel P_{(i,j)} is mapped to the following pixel (expressed by the equation (46)) of the destination image.

$$\begin{matrix}{F}^{( m )} ( i , j ) = \frac{( i , j ) + {\sum }_{h = 0}^{h = {n}_{s} - 1} ( {k}_{h} - {i}_{h} , {l}_{h} - {j}_{h} ) w e i g h {t}_{h} ( i , j )}{{2}^{n - m}} \\ w h e r e & ( 46 ) \\ w e i g h {t}_{h} ( i , j ) = \frac{1 / {‖ ( {i}_{h} - i , {j}_{h} - j ) ‖}^{2}}{total\_weight ( i , j )} \\ w h e r e & ( 47 ) \\ total\_weight ( i , j ) = {\sum }_{h = 0}^{h = {n}_{s} - 1} 1 / {‖ ( {i}_{h} - i , {j}_{h} - j ) ‖}^{2} & ( 48 )\end{matrix}$$

Second, the energy D_{(i,j)}^{(m,s)} of the candidate mapping f is changed so that a mapping f similar to F^{(m)} has a lower energy. Precisely speaking, D_{(i,j)}^{(m,s)} is expressed by the equation (49):

D_{(i,j)}^{(m,s)}=E₀_{_{(i,j)}}^{(m s)}+ηE_{(i,j)}^{(m s)}+κE₂_{_{(i i,j)}}^{(m,s)} (49)

where

$${E}_{{2}_{( i , j )}}^{( m , s )} = \{ \begin{matrix} 0 , & i f {‖ {F}^{( m )} ( i , j ) - {f}^{( m , s )} ( i , j ) ‖}^{2} \leq ⌊ \frac{{ρ}^{2}}{{2}^{2 ( n - m )}} ⌋ \\ {‖ {F}^{( m )} ( i , j ) - {f}^{( m , s )} ( i , j ) ‖}^{2} , & o t h e r w i s e\end{matrix} \qquad ( 50 )$$

where κ,ρ≧0. Finally, the resulting mapping f is determined by the above-described automatic computing process.

Note that E₂_{_{(i,j)}}^{(m,s)} becomes 0 if f^{(m,s)}(i,j) is sufficiently close to F^{(m)}(i,j) i.e., the distance therebetween is equal to or less than

$$⌊ \frac{{ρ}^{2}}{{2}^{2 ( n - m )}} ⌋ \qquad ( 51 )$$

This has been defined in this way because it is desirable to determine each value f^{(m,s)}(i,j) automatically to fit in an appropriate place in the destination image as long as each value f^{(m,s)}(i,j) is close to F^{(m)} (i,j). For this reason, there is no need to specify the precise correspondence in detail to have the source image automatically mapped so that the source image matches the destination image.

[2] Concrete Processing Procedure

The flow of a process utilizing the respective elemental techniques described in [1] will now be described.

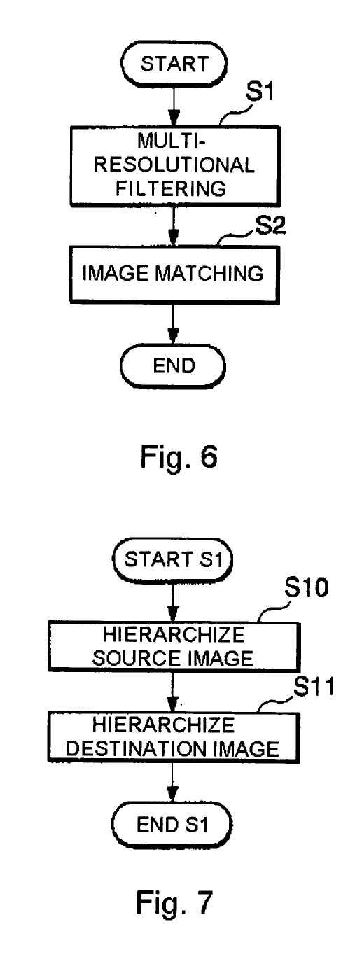

FIG. 6 is a flowchart of the overall procedure of the base technology. Referring to FIG. 6, a source image and destination image are first processed using a multiresolutional critical point filter (S1). The source image and the destination image are then matched (S2). As will be understood, the matching (S2) is not required in every case, and other processing such as image recognition may be performed instead, based on the characteristics of the source image obtained at S1.

FIG. 7 is a flowchart showing details of the process S1 shown in FIG. 6. This process is performed on the assumption that a source image and a destination image are matched at S2. Thus, a source image is first hierarchized using a critical point filter (S10) so as to obtain a series of source hierarchical images. Then, a destination image is hierarchized in the similar manner (S11) so as to obtain a series of destination hierarchical images. The order of S10 and S11 in the flow is arbitrary, and the source image and the destination image can be generated in parallel. It may also be possible to process a number of source and destination images as required by subsequent processes.

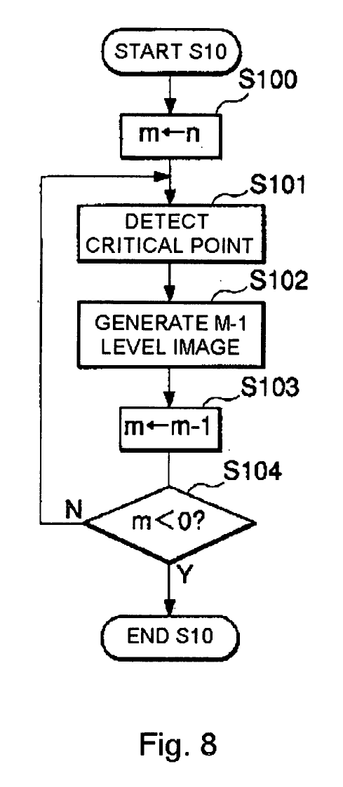

FIG. 8 is a flowchart showing details of the process at S10 shown in FIG. 7. Suppose that the size of the original source image is 2ⁿ×2ⁿ. Since source hierarchical images are sequentially generated from an image with a finer resolution to one with a coarser resolution, the parameter m which indicates the level of resolution to be processed is set to n (S100). Then, critical points are detected from the images p^{(m,0)}, p^{(m,1)}, p^{(m,2)} and p^{(m,3)} of the m-th level of resolution, using a critical point filter (S101), so that the images p^{(m-1,0)}, p^{(m-1, 1)}, p^{(m-1,2)} and p^{(m}^{-1,3)} of the (m−1)th level are generated (S102). Since m=n here, p^{(m,0)}=p^{(m,1)}=p^{(m,2)}=p^{(m,3)}=p⁽ⁿ⁾ holds and four types of subimages are thus generated from a single source image.

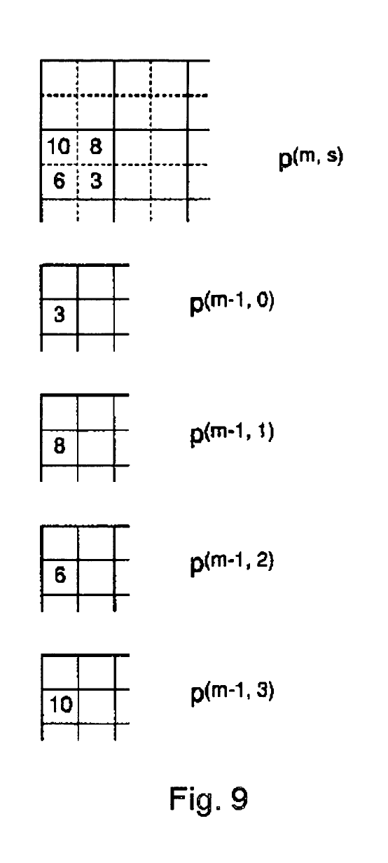

FIG. 9 shows correspondence between partial images of the m-th and those of (m−1)th levels of resolution. Referring to FIG. 9, respective numberic values shown in the figure represent the intensity of respective pixels. p^{(m,s)} symbolizes any one of four images p^{(m,0)} through p^{(m,3)}, and when generating p^{(m-1,0)}, p^{(m,0)} is used from p^{(m,s)}. For example, as for the block shown in FIG. 9, comprising four pixels with their pixel intensity values indicated inside, images p^{(m-1,0)} p^{(m-1,1)}, p^{(m-1,2)} and p^{(m-1,3)} acquire “3”, “8”, “6” and “10”, respectively, according to the rules described in [1.2]. This block at the m-th level is replaced at the (m−1)th level by respective single pixels thus acquired. Therefore, the size of the subimages at the (m−1)th level is 2^{m-1}X2^{m-1}.

After m is decremented (S103 in FIG. 8), it is ensured that m is not negative (S104). Thereafter, the process returns to S101, so that subimages of the next level of resolution, i.e., a next coarser level, are generated. The above process is repeated until subimages at m=0 (0-th level) are generated to complete the process at S10. The size of the subimages at the 0-th level is 1×1.

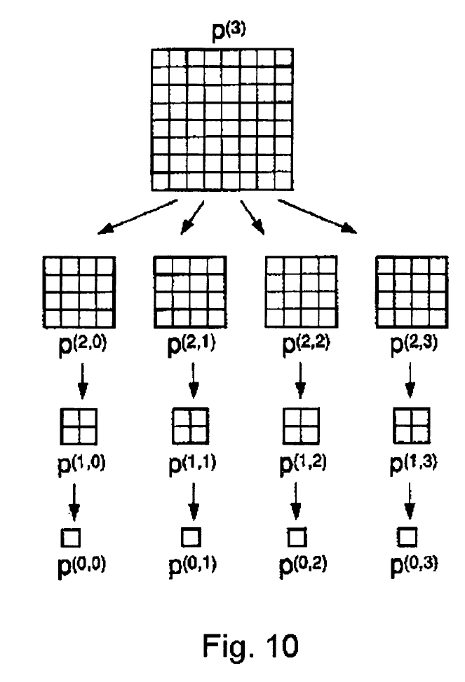

FIG. 10 shows source hierarchical images generated at S10 in the case of n=3. The initial source image is the only image common to the four series followed. The four types of subimages are generated independently, depending on the type of critical point. Note that the process in FIG. 8 is common to S11 shown in FIG. 7, and that destination hierarchical images are generated through a similar procedure. Then, the process at S1 in FIG. 6 is completed.

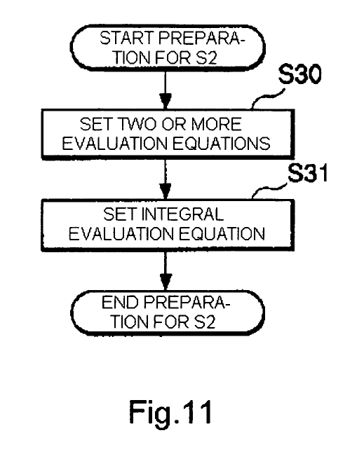

In this base technology, in order to proceed to S2 shown in FIG. 6a matching evaluation is prepared. FIG. 11 shows the preparation procedure. Referring to FIG. 11, a plurality of evaluation equations are set (S30). The evaluation equations may include the energy C_{f}^{(m,s)} concerning a pixel value, introduced in [1.3.2.1], and the energy D_{f}^{(m,s)} concerning the smoothness of the mapping introduced in [1.3.2.2]. Next, by combining these evaluation equations, a combined evaluation equation is set (S31). Such a combined evaluation equation may be [C_{(i,j)}^{(m,s)}+D_{f}^{(m,s)}. Using η introduced in [1.3.2.2], we have

ΣΣ(λC_{(i,j)}^{(m,s)}+ηE_{0(i,j)}^{(m,s)}+E_{1(i,j)}^{(m,s)}) (52)

In the equation (52) the sum is taken for each i and j where i and j run through 0, 1, . . . , 2^{m -1}. Now, the preparation for matching evaluation is completed.

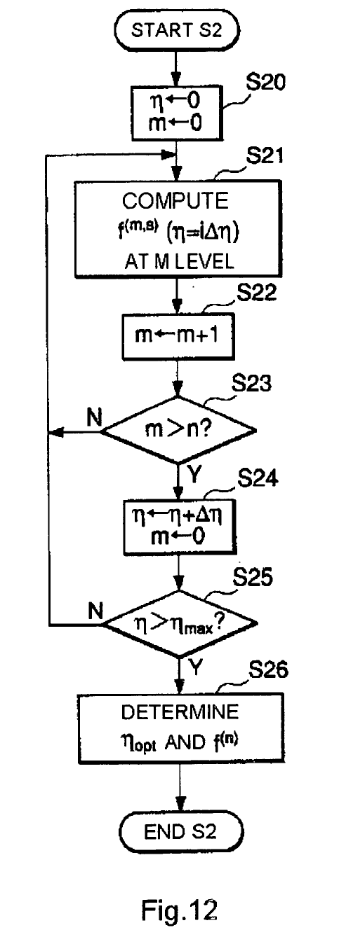

FIG. 12 is a flowchart showing the details of the process of S2 shown in FIG. 6. As described in [1], the source hierarchical images and destination hierarchical images are matched between images having the same level of resolution. In order to detect global correspondence correctly, a matching is calculated in sequence from a coarse level to a fine level of resolution. Since the source and destination hierarchical images are generated using the critical point filter, the location and intensity of critical points are stored clearly even at a coarse level. Thus, the result of the global matching is superior to conventional methods.

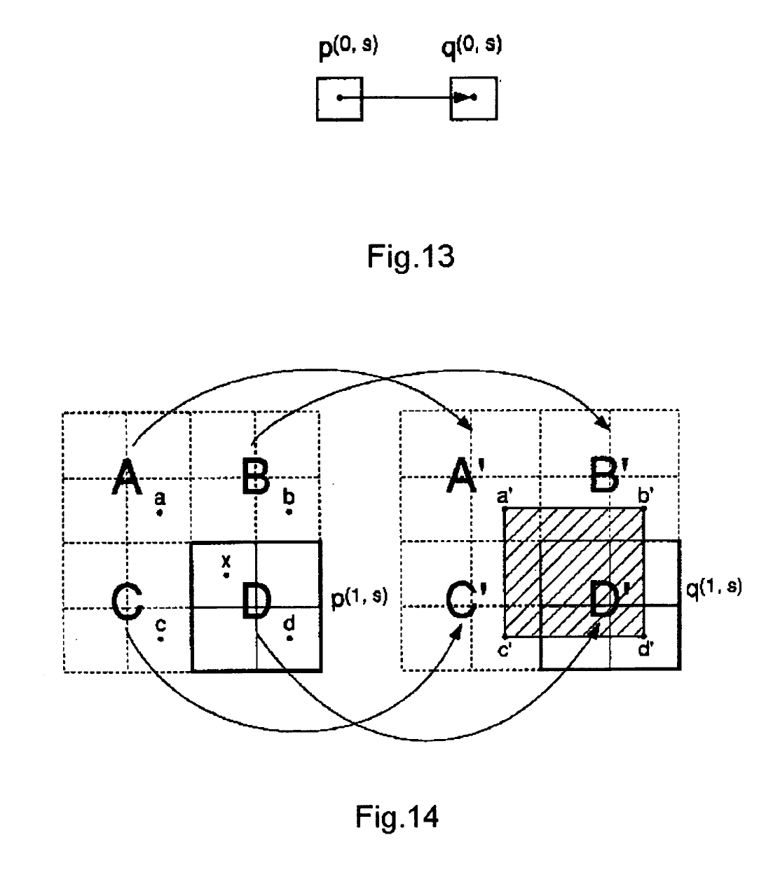

Referring to FIG. 12, a coefficient parameter fl and a level parameter m are set to 0 (S20). Then, a matching is computed between the four subimages at the m-th level of the source hierarchical images and those of the destination hierarchical images at the m-th level, so that four types of submappings f^{(m,s)}(s=0, 1, 2, 3) which satisfy the BC and minimize the energy are obtained (S21). The BC is checked by using the inherited quadrilateral described in [1.3.3]. In that case, the submappings at the m-th level are constrained by those at the (m−1)th level, as indicated by the equations (17) and (18). Thus, the matching computed at a coarser level of resolution is used in subsequent calculation of a matching. This is called a vertical reference between different levels. If m=0, there is no coarser level and this exceptional case will be described using FIG. 13.

A horizontal reference within the same level is also performed. As indicated by the equation (20) in [1.3.3], f^{(m,3)}, f^{(m,2)} and f^{(m,1)} are respectively determined so as to be analogous to f^{(m,2)}, f^{(m,1)} and f^{(m,0)}. This is because a situation in which the submappings are totally different seems unnatural even though the type of critical points differs so long as the critical points are originally included in the same source and destination images. As can been seen from the equation (20), the closer the submappings are to each other, the smaller the energy becomes, so that the matching is then considered more satisfactory.

As for f^{(m,0)}, which is to be initially determined, a coarser level by one may be referred to since there is no other submapping at the same level to be referred to as shown in the equation (19). In this base technology, however, a procedure is adopted such that after the submappings were obtained up to f^{(m,3)}, f^{(m,0)} is recalculated once utilizing the thus obtained subamppings as a constraint. This procedure is equivalent to a process in which s=4 is substituted into the equation (20) and f^{(m,4)} is set to f^{(m,0)} anew. The above process is employed to avoid the tendency in which the degree of association between f^{(m,0)} and f^{(m,3)} becomes too low. This scheme actually produced a preferable result. In addition to this scheme, the submappings are shuffled in the experiment as described in [1.7.1], so as to closely maintain the degrees of association among submappings which are originally determined independently for each type of critical point. Furthermore, in order to prevent the tendency of being dependent on the starting point in the process, the location thereof is changed according to the value of s as described in [1.7].

FIG. 13 illustrates how the submapping is determined at the 0-th level. Since at the 0-th level each sub-image is consitituted by a single pixel, the four submappings f^{(0,s)} are automatically chosen as the identity mapping. FIG. 14 shows how the submappings are determined at the first level. At the first level, each of the sub-images is constituted of four pixels, which are indicated by solid lines. When a corresponding point (pixel) of the point (pixel) x in p^{(1,s)} is searched within q^{(1,s)}, the following procedure is adopted:

1. An upper left point a, an upper right point b, a lower left point c and a lower right point d with respect to the point x are obtained at the first level of resolution.

2. Pixels to which the points a to d belong at a coarser level by one, i.e., the 0-th level, are searched. In FIG. 14, the points a to d belong to the pixels A to D, respectively. However, the pixels A to C are virtual pixels which do not exist in reality.

3. The corresponding points A′ to D′ of the pixels A to D, which have already been defined at the 0-th level, are plotted in q^{(1,s)}. The pixels A′ to C′ are virtual pixels and regarded to be located at the same positions as the pixels A to C.

4. The corresponding point a′ to the point a in the pixel A is regarded as being located inside the pixel A′, and the point a′ is plotted. Then, it is assumed that the position occupied by the point a in the pixel A (in this case, positioned at the lower right) is the same as the position occupied by the point a′ in the pixel A′.

5. The corresponding points b′ to d′ are plotted by using the same method as the above 4 so as to produce an inherited quadrilateral defined by the points a′ to d′.

6. The corresponding point x′ of the point x is searched such that the energy becomes minimum in the inherited quadrilateral. Candidate corresponding points x′ may be limited to the pixels, for instance, whose centers are included in the inherited quadrilateral. In the case shown in FIG. 14, the four pixels all become candidates.

The above described is a procedure for determining the corresponding point of a given point x. The same processing is performed on all other points so as to determine the submappings. As the inherited quadrilateral is expected to become deformed at the upper levels.(higher than the second level), the pixels A′ to D′ will be positioned apart from one another as shown in FIG. 3.

Once the four submappings at the m-th level are determined in this manner, m is incremented (S22 in FIG. 12.). Then, when it is confirmed that m does not exceed n (S23), return to S21. Thereafter, every time the process returns to S21, submappings at a finer level of resolution are obtained until the process finally returns to S21 at which time the mapping f⁽ⁿ⁾ at the n-th level is determined. This mapping is denoted as f⁽ⁿ⁾(η=0) because it has been determined relative to η=0.

Next, to obtain the mapping with respect to other different η,η is shifted by Δη and m is reset to zero (S24). After confirming that new η does not exceed a predetermined search-stop value ηₘₐₓ(S25), the process returns to S21 and the mapping f⁽ⁿ⁾ (η=Δη) relative to the new η is obtained. This process is repeated while obtaining f⁽ⁿ⁾(η=iΔη)(i=0,1, . . .)at S21. When η exceeds ηₘₐₓ, the process proceeds to S26 and the optimal η=ηₒₚₜ is determined using a method described later, so as to let f⁽ⁿ⁾ (η32 ηₒₚₜ) be the final mapping f⁽ⁿ⁾.

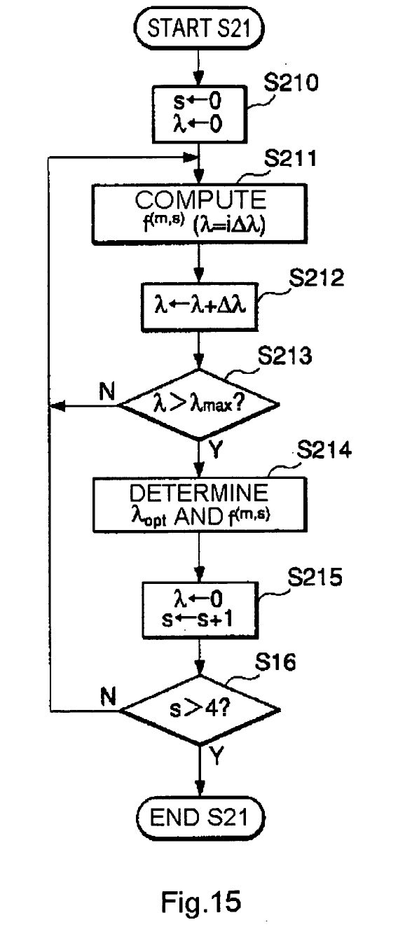

FIG. 15 is a flowchart showing the details of the process of S21 shown in FIG. 12. According to this flowchart, the submappings at the m-th level are determined for a certain predetermined η. In this base technology, when determining the mappings, the optimal λ is defined independently for each submapping.

Referring to FIG. 15, s and η are first reset to zero (S210). Then, obtained is the submapping f^{(m,s)} that minimizes the energy with respect to the then λ (and, implicitly, η) (S211), and the thus obtained submapping is denoted as f^{(m,s)}(λ=0). In order to obtain the mapping with respect to other different λ, λ is shifted by Δλ. After confirming that the new λ does not exceed a predetermined search-stop value λₘₐₓ (S213), the process returns to S211 and the mapping f^{(m,s)} (λ=Δλ) relative to the new λ is obtained. This process is repeated while obtaining f^{(m,s)}(λ=iΔλ)(i=0,1, . . . ). When λ exceeds λₘₐₓ, the process proceeds to S214 and the optimal λ=λₒₚₜ is determined, so as to let f⁽ⁿ⁾(λ=λₒₚₜ) be the final mapping f_{(m,s)} (S214).

Next, in order to obtain other submappings at the same level, λ is reset to zero and s is incremented (S215). After confirming that s does not exceed 4 (S216), return to S211. When s=4, f^{(m,0)} is renewed utilizing f^{(m,3)} as described above and a submapping at that level is determined.

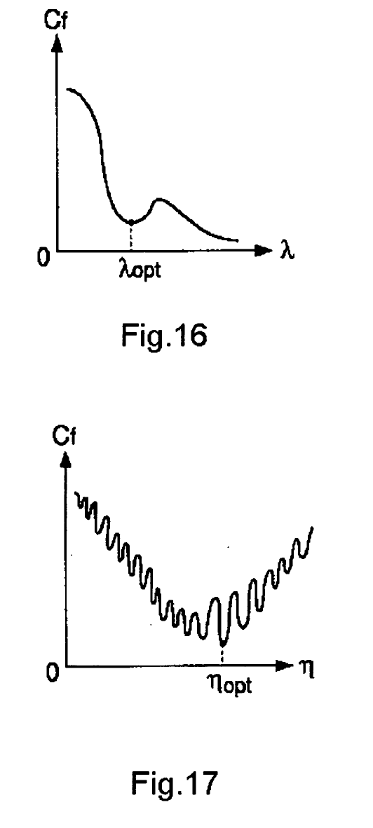

FIG. 16 shows the behavior of the energy C_{f}^{(m,s)} corresponding to f^{(m,s)}(λ=iΔλ)(i=0,1, . . .) for a certain m and s while varying λ. As described in [1.4], as λ increases, C_{f}^{(m,s)} normally decreases but changes to increase after λ exceeds the optimal value. In this base technology, λ in which C_{f}^{(m,s)} becomes the minima is defined as λₒₚₜ. As observed in FIG. 16, even if C_{f}^{(m,s)} begins to decrease again in the range λ>λₒₚₜ, the mapping will not be as good. For this reason, it suffices to pay attention to the first occurring minima value. In this base technology, λₒₚₜ is independently determined for each submapping including f⁽ⁿ⁾.

FIG. 17 shows the behavior of the energy C_{f}⁽ⁿ⁾ corresponding to f⁽ⁿ⁾(η=iΔη)(i=0,1 . . . ) while varying η. Here too, C_{f}⁽ⁿ⁾ normally decreases as η increases, but C_{f}⁽ⁿ⁾ changes to increase after η exceeds the optimal value. Thus, η in which C_{f}⁽ⁿ⁾ becomes the minima is defined as ηₒₚₜ. FIG. 17 can be considered as an enlarged graph around zero along the horizontal axis shown in FIG. 4. Once ηₒₚₜ is determined, f⁽ⁿ⁾ can be finally determined.

As described above, this base technology provides various merits. First, since there is no need to detect edges, problems in connection with the conventional techniques of the edge detection type are solved. Furthermore, prior knowledge about objects included in an image is not necessitated, thus automatic detection of corresponding points is achieved. Using the critical point filter, it is possible to preserve intensity and locations of critical points even at a coarse level of resolution, thus being extremely advantageous when applied to object recognition, characteristic extraction, and image matching. As a result, it is possible to construct an image processing system which significantly reduces manual labor.

Some further extensions to or modifications of the above-described base technology may be made as follows:

(1) Parameters are automatically determined when the matching is computed between the source and destination hierarchical images in the base technology. This method can be applied not only to the calculation of the matching between the hierarchical images but also to computing the matching between two images in general.

For instance, an energy E₀ relative to a difference in the intensity of pixels and an energy E₁ relative to a positional displacement of pixels between two images may be used as evaluation equations, and a linear sum of these equations, i.e., Eₜₒₜ=αE₀+E₁, may be used as a combined evaluation equation. While paying attention to the neighborhood of the extrema in this combined evaluation equation, α is automatically determined. Namely, mappings which minimize Eₜₒₜ are obtained for various α's. Among such mappings, α at which Eₜₒₜ takes the minimum value is defined as an optimal parameter. The mapping corresponding to this parameter is finally regarded as the optimal mapping between the two images.

Many other methods are available in the course of setting up evaluation equations. For instance, a term which becomes larger as the evaluation result becomes more favorable, such as 1/E₁ and 1/E₂, may be employed. A combined evaluation equation is not necessarily a linear sum, but an n-powered sum (n=2, ½, −1, −2, etc.), a polynomial or an arbitrary function may be employed when appropriate.

The system may employ a single parameter such as the above α, two parameters such as η and λ as in the base technology, or more than two parameters. When there are more than three parameters used, they may be determined while changing one at a time.

(2) In the base technology, a parameter is determined in a two-step process. That is, in such a manner that a point at which C_{f}^{(m,s)} takes the minima is detected after a mapping such that the value of the combined evaluation equation becomes minimum is determined. However, instead of this two-step processing, a parameter may be effectively determined, as the case may be, in a manner such that the minimum value of a combined evaluation equation becomes minimum. In this case, αE₀+βE₁, for example, may be used as the combined evaluation equation, where α+β=1 may be imposed as a constraint so as to equally treat each evaluation equation. The automatic determination of a parameter is effective when determining the parameter such that the energy becomes minimum.

(3) In the base technology, four types of submappings related to four types of critical points are generated at each level of resolution. However, one, two, or three types among the four types may be selectively used. For instance, if there exists only one bright point in an image, generation of hierarchical images based solely on f^{(m,3)} related to a maxima point can be effective to a certain degree. In this case, no other submapping is necessary at the same level, thus the amount of computation relative on s is effectively reduced.

(4) In the base technology, as the level of resolution of an image advances by one through a critical point filter, the number of pixels becomes ¼. However, it is possible to suppose that one block consists of 3×3 pixels and critical points are searched in this 3×3 block, then the number of pixels will be 1/9 as the level advances by one.

(5) In the base technology, if the source and the destination images are color images, they would generally first be converted to monochrome images, and the mappings then computed. The source color images may then be transformed by using the mappings thus obtained. However, as an alternate method, the submappings may be computed regarding each RGB component.

[3] Improvements in the Base Technology

The base technology above may also be further refined or improved to yield more precise matching. Some improvements are hereinafter described.

[3.1] Critical Point Filters and Subimages Considering Color Information

The critical point filters of the base technology may be revised to make effective use of the color information in the images. First, a color space is introduced using HIS (hue, intensity, saturation), which is considered to be closest to human intuition. Further, a formula for intensity which is considered closest to human visual sensitivity is used for the transformation of color into intensity.

$$H = \frac{\frac{π}{2} - {tan}^{- 1} ( \frac{2 R - G - R}{\sqrt{3 ( G - B )}} )}{2 π} \\ I = \frac{R + G + B}{3} \\ S = 1 - \frac{min ( R , G , B )}{3} \\ Y = 0.299 \times R + 0.587 \times G + 0.114 \times B \qquad ( 53 )$$

Here, the following definitions are made, in which the intensity Y and the saturation S at a pixel “a” are respectively denoted by Y(a) and S(a).

$${α}_{Y} ( a , b ) = \{ \begin{matrix}a … ( Y ( a ) \leq Y ( b ) ) \\ b … ( Y ( a ) > Y ( b ) )\end{matrix} \\ {β}_{Y} ( a , b ) = \{ \begin{matrix}a … ( Y ( a ) \geq Y ( b ) ) \\ b … ( Y ( a ) < Y ( b ) )\end{matrix} \\ {β}_{S} ( a , b ) = \{ \begin{matrix}a … ( S ( a ) \geq S ( b ) ) \\ b … ( S ( a ) < S ( b ) )\end{matrix} \qquad ( 54 )$$

The following five filters are then prepared based on the definition described above.

p_{(i,j)}^{(m,0)}=β_{Y}(β_{Y}(p_{(2i,2j)}^{(m+1.0)},p_{(2i,2j)}^{(m+1.0)}),β_{Y}(p_{(2i+1,2j)}^{(m+1.0)},p_{2i+1.2j+1)}^{(m+1.0)}))

p_{(i,j)}^{(m,l)}=α_{Y}(β_{Y}(p_{(2i,2j)}^{(m+1,2)},p_{2i,2j+1)}^{(m+1,2)}),β_{Y}(p_{2i+1,2j)}^{m+1,1)},p_{(2i+1,2j+1)}^{(m+1.1)}))

p_{(i,j)}^{(m,2)}=β_{Y}(α_{y}(p_{(2i,2j)}^{(m+1,2)},p_{2i,2j+1)}^{(m+1,2)}),α_{Y}(p_{(2i+1,2j)}^{(m+1,2)}, p_{(2i+1,2j+1)}^{(m+1,3)}))

p_{(i,j)}^{(m,3)}α_{Y}(α_{Y}(p_{(2i,2j)}^{(m+1,3)},p_{(2i,2j+1)}^{(m+1,3)}),α_{Y}(p_{(2i+1,2j)}^{(m+1,3)},p_{(2i+1,2j+1)}^{(m+1,3)}))

p_{(i,j)}^{(m,4)}=β_{S}(β_{S}(p_{(2i,2j)}^{(m+1,4)},p_{(2i,2j+1)}^{(m+1,4}),β_{S}(p_{(2i+1,2j)}^{(m+1,4)},p_{(2i+1,2j+1)}^{(m+1,4)})) (55)

The top four filters in (55) are almost the same as those in the base technology, and accordingly, critical points of intensity are preserved with color information. The last filter preserves critical points of saturation, also together with the color information.

At each level of resolution, five types of subimage are generated by these filters. Note that the subimages at the highest level are consistent with the original image.

p_{(i,j)}^{(n,0)}=p_{(i,j)}^{(n,j)}=p_{(i,j)}^{(n,3)}=p_{(i,j)}^{(n,4)}=p_{(i,j)} (56)

[3.2] Edge Images and Subimages

An edge detection filter using the first order derivative is introduced to incorporate information related to intensity derivation (edge) for matching. This filter can be obtained by convolution integral with a given operator H.

p_{(i,j)}^{(n,h)}=Y(p_{(i,j)}) [symbol] Hₕ

p_{(i,j)}^{(n,v)}=Y(p_{(i,j)}) [symbol] Hᵥ (57)

In this improved technology, the operator H is described, in consideration of the computing speed, as follows:

$${H}_{h} = \frac{1}{4} [ \begin{matrix}1 & 0 & - 1 \\ 2 & 0 & - 2 \\ 1 & 0 & - 1\end{matrix} ] \\ {H}_{v} = \frac{1}{4} [ \begin{matrix}1 & 2 & 1 \\ 0 & 0 & 0 \\ - 1 & - 2 & - 1\end{matrix} ] \qquad ( 58 )$$

Next, the image is transformed into the multiresolution hierarchy. Because the image generated by the edge detection filter has an intensity with a center value of 0, the most suitable subimages are the mean value images as follows:

$${p}_{( i , j )}^{( m , h )} = \frac{1}{4} ( {p}_{( 2 i , 2 j )}^{( m + 1 , h )} + {p}_{( 2 i , 2 j + 1 )}^{( m + 1 , h )} + {p}_{( 2 i + 1 , 2 j )}^{( m + 1 , h )} + {p}_{( 2 i + 1 , 2 j + 1 )}^{( m + 1 , h )} ) \\ {p}_{( i , j )}^{( m , v )} = \frac{1}{4} ( {p}_{( 2 i , 2 j )}^{( m + 1 , v )} + {p}_{( 2 i , 2 j + 1 )}^{( m + 1 , v )} + {p}_{( 2 i + 1 , 2 j )}^{( m + 1 , v )} + {p}_{( 2 i + 1 , 2 j + 1 )}^{( m + 1 , v )} ) \qquad ( 59 )$$

The images described in equation (59) are introduced to the energy function for computation during the “forward stage”, that is, the stage in which an initial submapping is derived, as will hereinafter be described in more detail.

The magnitude of the edge, i.e., the absolute value is also necessary for the calculation.

p_{(i i,j)}^{(n,e)}=√(p_{(i,j)}^{(n,h)})²+(p_{(i,j)}^{(n,v)})² (60)

Because this value will always be positive, a maximum value filter can be used for the transformation into the multiresolutional hierarchy.

p_{(i,j)}^{(m,e)}=β_{Y}(β_{Y}(p_{(2i,2j)}^{(m+1,e)},p_{(2i,2j+1)}^{(m+1,e)}),β_{Y}(p_{(2i+1,2j+1)}^{(m+1,e)})) (61)

The image described in equation (61) is introduced in the course of determining the order of the calculation in the “forward stage” described below.

[3.3] Computing Procedures

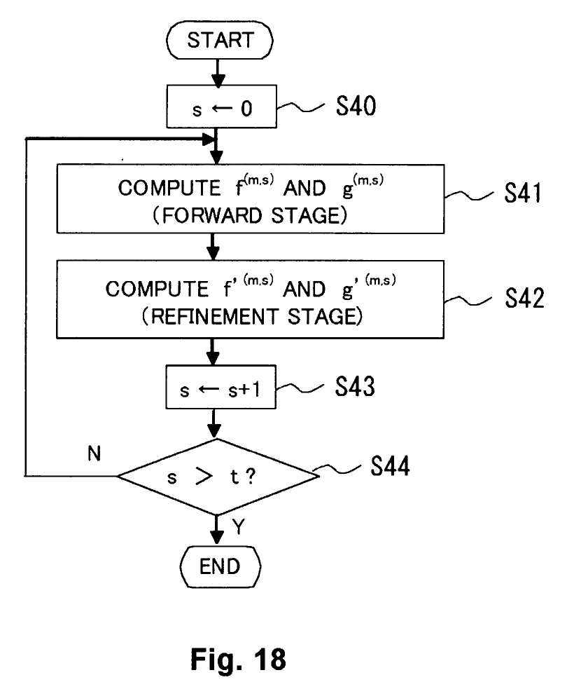

The computing proceeds in order from the subimages with the coarsest resolution. The calculations are performed more than once at each level of the resolution due to the five types of subimages. This is referred to as a “turn”, and the maximum number of turns is denoted by t. Each turn includes energy minimization calculations both in a “forward stage” mentioned above, and in a “refinement stage”, that is, a stage in which the submapping is recomputed based on the result of the forward stage. FIG. 18 shows a flowchart related to the improved technology illustrating the computation of the submapping at the m-th level.

As shown in the figure, s is set to zero (S40) initially. Then the mapping f^{(m,s)} of the source image to the destination image is computed by energy minimization in the forward stage (S41). The energy minimized here is the linear sum of the energy C, concerning the value of the corresponding pixels, and the energy D, concerning the smoothness of the mapping.

In this improved technology, the energy C includes the energy C_{I} concerning the intensity difference, which is the same as the energy C in the base technology described in sections [1] and [2] above, the energy C_{c} concerning the hue and the saturation, and the energy C_{E} concerning the difference of the intensity derivation (edge). These energies are described as follows:

C_{I}^{f}(i,j)=|Y(p_{(i,j)}^{(m,φ(t))})−Y(q_{f(i,j)}^{(m,φ(t))})|²

C_{c}^{f}(i,j)=|S(p_{(i,j)}^{(m,φ(t))})cos(2πH(p_{(i,j)}^{(m,φ(t))}))−S(q_{f(i,j)}^{(m,φ(t))})cos(2πH(q_{f(i,j)}^{(m,φ(t))}))|²+|S(p_{(i,j)}^{(m,100(t))})sin(2πH(p_{(i,j)}^{(m,φ(t))}))−S

(q_{f(i,j)}^{(m,φ(t))})sin(2πH(q_{f(i,j)}^{(m,φ(t))}))|²

C_{E}^{f}(i,j)=|p_{(i,j)}^{(m,h)}−q_{f(i,j)}^{(m,h)}|²+p_{(i,j)}^{(m,v)}−q_{f(i,j)}^{(m,v)}|² (62)

The energy D is similar to that in the base technology described above. However, in the base technology, only the adjacent pixels are taken into account when the energy E₁, which deals with the smoothness of the images, is derived, whereas, in this improved technology, the number of ambient pixels taken into account can be set as a parameter d.

$${E}_{0}^{f} ( i , j ) = {‖ f ( i , j ) - ( i , j ) ‖}^{2} \\ {E}_{1}^{f} ( i , j ) = {\sum }_{{i}^{′} = i - d}^{i + d} {\sum }_{{j}^{′} = j - d}^{j + d} {‖ ( f ( i , j ) - ( i , j ) ) - ( f ( {i}^{′} , {j}^{′} ) - ( {i}^{′} , {j}^{′} ) ) ‖}^{2} \qquad ( 63 )$$

In preparation for the refinement stage, the mapping g^{(m,s)} of the destination image q to the source image p is also computed in the forward stage.

In the refinement stage (S42), a more appropriate mapping f′^{(m,s)} is computed based on the bidirectional mappings, f^{(m,s)} and g^{(m,s)}, which were previously computed in the forward stage. In this refinement stage, an energy minimization calculation for an energy M is performed. The energy M includes a measurement of the degree of conformation to the mapping g of the destination image to the source image, M₀, and the difference from the initial mapping, M₁.

M₀^{f′}(i,j)=∥g(f′(i,j))−(i,j)∥²

M₁^{f′}(i,j)=∥f′(i,j)−f(i,j)∥² (64)

The mapping g′^{(m,s)} of the destination image q to the source image p is also computed in the same manner, in order to maintain the symmetry.

Thereafter, s is incremented (S43), and if s does not exceed t (S44), the computation proceeds to the forward stage in the next turn (S41). In so doing, the energy minimization calculation is performed using a substituted E₀, which is described as follows:

E₀^{f}(i,j)=∥f(i,j)−f′(i,j)∥² (65)

[3.4] Order of Mapping Calculation

Because the energy concerning the mapping smoothness, E₁, is computed using the mappings of the ambient points, the energy depends on whether those points are previously computed or not. Therefore, the total mapping preciseness significantly depends on the point from which the computing starts and the order in which points are processed. In order to overcome this concern, an image having an absolute value of edge (see equation (61)) is introduced. Because the edge generally has a large amount of information, the mapping calculation proceeds from a point at which the absolute value of edge is the largest.

Generally, the improved technique described in this section [3] can make the mapping extremely precise, in particular, for binary images and the like.

Preferred Embodiments Concerning Image Processing

Image processing techniques utilizing the above-described base technology will now be described. First, the general concepts of the image processing techniques will be described and then a more detailed description will be provided. Generally speaking, the image processing techniques deal with encoding and decoding of images together with sound data. During image encoding, key frames are imprinted with a corresponding point file of the key frames and sound data which is to be reproduced synchronously with a motion picture that is reproduced by using the key frames and the corresponding point file. Imprinting can be realized by various known or hereafter developed watermark techniques,. Prior to imprinting the sound data, it is preferable that the sound data are compressed by a suitable compression systems such as MP3 or another appropriate method.

During decoding, the corresponding point file and sound data are extracted from the key frames, a motion picture is reproduced by generating intermediate frames from the corresponding point file and the key frames, and the sound data are decoded and reproduced synchronously with the motion picture.

In order to synchronize the sound data and the motion picture (image frames), the sound data or the key frames may include information regarding timing, and especially information regarding the timing and synchronism of the sound data and the key frames. As a simple example, sound data which should be reproduced between a key frame KF1 and a key frame KF2 (i.e. a portion of sound data that would ordinarily be synchronized as being between the key frame KF1 and the key frame KF2) may be imprinted into the key frame KF1 by dividing the overall sound data in accordance with the number and/or spacing of the key frames. In this case, subsequent sound data, which should be reproduced between the key frame KF2 and a key frame KF3, can be imprinted into the key frame KF2. Similarly, sound data which is to-be reproduced between a certain key frame and a next key frame may be imprinted into .the earlier key frame. This simple example illustrates that timing or synchronization information may include information other than just information regarding time. As another example, a relatively large amount of sound data may be imprinted into a prescribed key frame and the sound data may then be divided into packets or groups, each packet or group including a header region which describes the timing for reproducing the sound data, for example, as information regarding the time or correspondence relation to the key frames.

Before describing the above image processing techniques in a more specific manner, the use of a mesh to provide effective compression of the corresponding point file will first be described. Since corresponding point file and sound data are imprinted into key frames according to embodiments of the present invention, it is generally preferable that the corresponding point file and the sound data be relatively small.

FIG. 19 shows a first image I1 and a second image I2, which serve as key frames, where certain pixels p₁(x₁, y₁) and P₂(x₂, y₂) correspond therebetween. The correspondence of these pixels may be obtained using the base technology.

Referring to FIG. 20, if a mesh is provided on the first image I1, corresponding positions of points in the mesh can be determined on the second image I2. In particular, a polygon R1 in the first image I1 may be determined by four lattice points A, B, C and D. This polygon R1 is called a “source polygon”. As is shown in FIG. 20, these lattice points A, B, C and D have respectively corresponding points A′, B′, C′ and D′ on the second image I2, and a polygon R2 formed thus by the corresponding points is called a “destination polygon.” In this embodiment, the source polygon is generally a rectangle, while the destination polygon is generally a quadrilateral. In any event, according to the present embodiment, the correspondence relation between the first and second images I1 and I2 is not described pixel by pixel, but instead, the correspondence is described with respect to the lattice points of the source polygon and such a description is written in a corresponding point file. By directing attention to the lattice points, the volume of the corresponding point file can be reduced significantly.

As described in the base technology section, the corresponding point file is utilized for generating intermediate images between the first image I1 and the second image I2. In particular, intermediate images at arbitrary positions between the key frames can be generated by interpolating between the corresponding points. Thus, by using the first image I1, the second image I2 and the corresponding point file, morphing between the two images and the generation of smooth motion pictures is possible. This technique thus provides a compression effect for motion pictures with many possible applications.

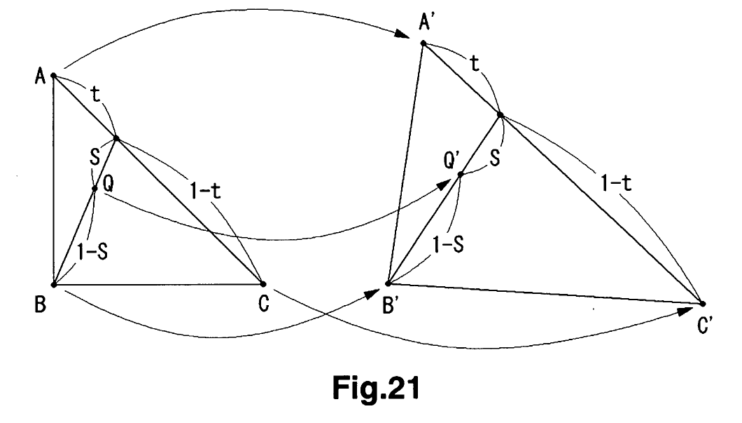

FIG. 21 shows an example method for computing a correspondence relation for points other than the lattice points based on the corresponding point file. Since in the corresponding point file there is only information on the lattice points, data corresponding to interior points of each polygon must be computed separately. FIG. 21 shows a correspondence between a triangle ABC (which corresponds to a lower half of the source polygon R1 shown in FIG. 20) and a triangle A′B′C′ (which corresponds to that of the destination polygon R2 shown in FIG. 20). Now, for an interior point Q of triangle ABC, an intersection point of a line segment AC and an extended line of BQ to AC through the interior point Q interior-divides the line segment AC in the ratio t:(1-t) and the point Q interior-divides a line segment connecting the AC interior-dividing point and the point B in the ratio s:(1-s). Similarly, for a corresponding point Q′ of triangle A′B′C′, an intersection point of a line segment A′C′ and an extended line of B′Q′ to A′C′ through a corresponding point Q′, which corresponds to the point Q interior-divides the line segment A′C′ in the ratio t:(1-t) and the point Q′ interior-divides a line segment connecting the A′C′ interior-dividing point and a point B′, corresponding to B, in the ratio s:(1-s). Namely, it is preferable that the source polygon is divided into triangles, and interior points of the destination polygon are determined by using interior division of the vectors concerning the triangle. When expressed in a vector skew field, this becomes

BQ=(1−s){(1−t)BA+tBC},

thus, we have

B′Q′=(1−s){(1−t)B′A′+tB′C′}

Of course, similar processing will also be performed between a triangle ACD which is an upper half of the source polygon R1 and a triangle A′C′D′ which is an upper half of the destination polygon R2.

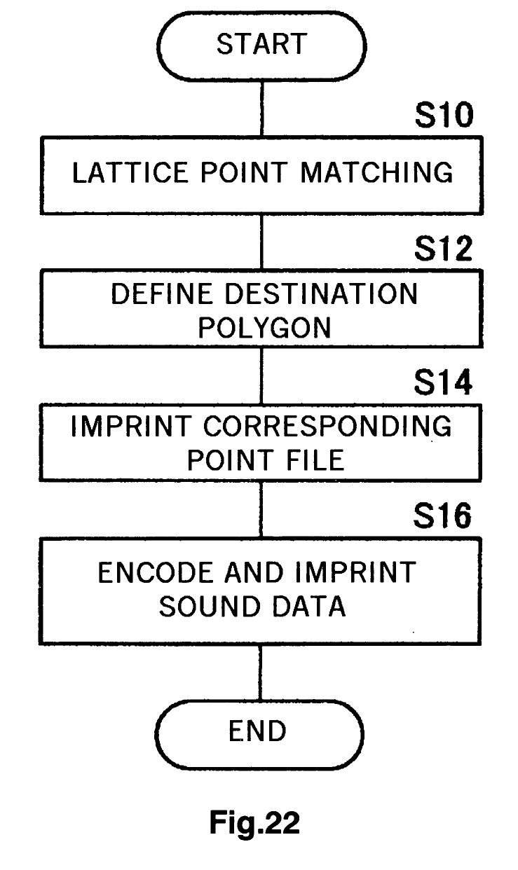

FIG. 22 shows a flowchart of the encoding procedure described generally above. Firstly, matching results for the lattice points taken on the first image I1 are acquired (S10) as shown in FIG. 20. In the matching, it is preferable that the pixel-by-pixel matching according to the base technology is first performed and then a portion corresponding to the lattice points is extracted from those results. It is to be noted that the matching results on the lattice points may alternatively be specified based on other matching techniques such as optical flow and block matching or the like, instead of using the pixel matching of the base technology.

Next, destination polygons are defined on the second image 12 (S12), as shown in the right side of FIG. 20. These procedures complete the generation of the corresponding point file.

In this embodiment, the corresponding point file is then imprinted into the first image I1 (S14). It has been determined in an experiment that high quality intermediate frames with, for example, a resolution of about 256×256 pixels can be created from a corresponding point file in the range of 10s of kBytes or less. Such a corresponding point file can be generated using the mesh and lattice points described above. The size of the data imprinted into the first image I1 will therefore be in the range of 10s of kBytes or less and there are known watermark techniques which can be used to imprint this amount of data into an image. For example, a modulo masking method, a density pattern method which manipulates the information of pixel intensity, or an ordered dither method which manipulates the information of thresholds can be used. Any appropriate technique that is known or becomes known may be used for imprinting in this embodiment. It is known, for example, that text data of up to about 70 kBytes can be imprinted by the density pattern method into an image of 256×256 pixels X 8 bits without significantly spoiling of the optical quality of the image, and, as such, this method is suitable for this embodiment.

The sound data are also acquired and are then imprinted into the key frames (S16). Generally, depending on the application, the sound data will be encoded or compressed with an appropriate method. As an example, if the time interval between the key frames is one second, it is then sufficient if only one second of sound data is imprinted into each key frame. Since, depending on the parameters, music data of one minute can be compressed to data of about 1 Mbyte using MP3, one second of sound data can be compressed to less than 20 kByte. In such a case, the sound data can be easily imprinted into the key frame together with the corresponding point file.

Note that it is not necessary that the sound data and the key frames to which the sound data are imprinted match with each other. If more time is needed for decoding the sound data, it can be secured, for example, by imprinting the sound data which is to be reproduced at a later timing into earlier key frames. Similarly, if more time is needed for image processing, the sound data may be imprinted into later key frames. Generally, it may be preferable to have a prescribed time lag between the key frames and the sound data.

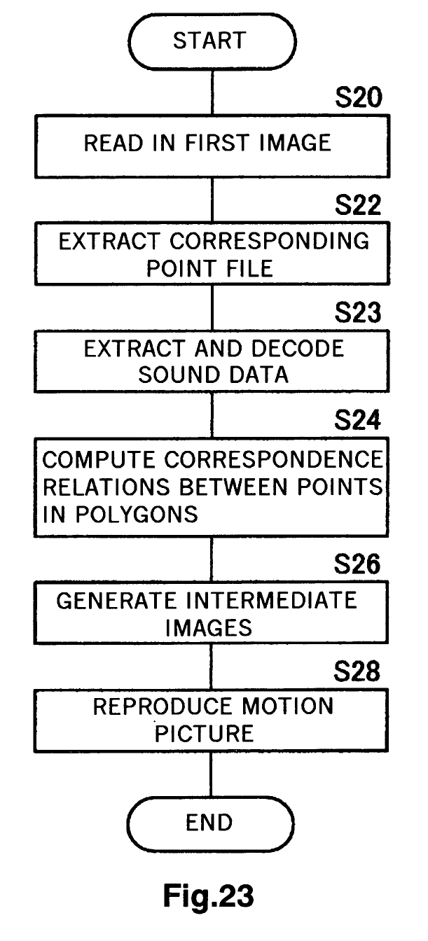

The processing at a decoding side is now described with reference to FIG. 23, which shows a flowchart of an example procedure at the decoding side. Generally speaking, this procedure involves receiving a stream of key frames with corresponding point files and sound data imprinted therein and generating intermediate images to provide a motion picture. The first image I1 is first read in (S20) and the corresponding point file is extracted (S22). It is premised, therefore, that the encoding side and the decoding side both have common knowledge about the method for imprinting. Methods for extraction of imprinted data are known for each watermark technique, such as modulo masking, described above and may be utilized as appropriate. Next, the sound data are similarly extracted and, if necessary, decoded (S23).

Thereafter, the correspondence relation between points in source polygons and destination polygons is computed using, for example, the method shown in FIG. 21 (S24). At this time, the correspondence relation on all pixels within. the image can be acquired. Next, as described in the base technology, the coordinates and colors of points corresponding to each other are interpolated so that an intermediate image in a position which interior-divides, with respect to time, in the ratio u:(1-u) between the first image I1 and the second image I2 can be generated (S26). The combined motion picture can then be provided by reproducing the sound data synchronously with the reproduction of the key frames and the generated intermediate frames (S28).

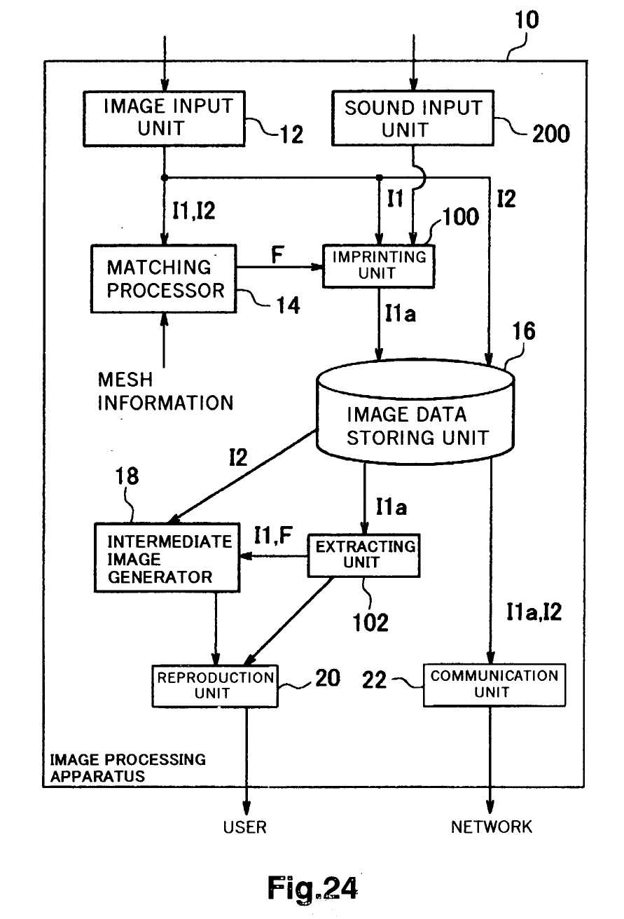

FIG. 24 shows an example image processing apparatus 10 which may perform the above-described procedures. The apparatus 10 comprises an image input unit 12 which acquires the first image I1 and the second image 12 from, for example, an external storage device, a photographing camera or the like, a matching processor 14 which performs a matching computation on the first image I1 and the second image I2 using the base technology or another appropriate technique, a sound input unit 200, which may be a microphone or the like, that receives or acquires the sound data in parallel with the shooting or capture of the images I1 and I2, an imprinting unit 100 which imprints the corresponding point file F generated by the matching processor 14 and the sound data into the first image I1, an image data storing unit 16 which stores the first image I1a altered as a result of imprinting (hereinafter referred to as an “altered first image”), the second image I2 and other images, an extracting unit 102 which extracts the corresponding point file F and the sound data from the altered first image I1a, an intermediate image generator 18 which generates intermediate images between the first image I1 and the second image I2 from the first image I1 acquired by removing the imprinted data from the altered first image I1a and the second image I2, and a reproduction unit 20 which displays the first image I1, the second image 12 and the intermediate images synchronously with the sound data as a series of images similar to an originally encoded motion picture. Alternatively, a communication unit 22 may send out the altered first image I1a, the second image 12 and other images to a transmission infrastructure such as a network or the like according to a request from an external unit (not shown). As shown in FIG. 24, mesh data which indicate the size of the mesh, the positions of the lattice points and so forth may be input to the matching processor 14.

The image input unit 12 and the sound input unit 200 may, for example, acquire the encoded data of the images and the sound from a motion picture which is previously encoded in MPEG format. In this case, an MPEG decoding unit or a subset thereof (not shown) may be provided prior to the image input unit 12 and the sound input unit 200 or may be provided in the reproduction unit 20 with appropriate data pathways. There are, moreover, many other methods for acquiring the images and the sound, and it is to be noted that the method for acquiring the images and the sound is not necessarily limited to any one of these methods.

The image processing apparatus 10 described above is a combination of the structures for encoding and decoding. It will be understood that the image input unit 12, sound input unit 200, matching processor 14 and imprinting unit 100 are the structures for encoding and the extracting unit 102, intermediate image generator 18, and reproduction unit 20 are the structures for decoding. The image data storing unit 16 and communication unit 22 may be common to both encoding and decoding structures and may be provided as appropriate if encoding and decoding are performed by separate apparatuses.

In operation, the first image I1 and the second image I2 are received or input in the image input unit 12 and are then sent to the matching processor 14. The matching processor 14 performs a matching computation, for example, a pixel-by-pixel matching computation, between the images I1 and I2 and generates a corresponding point file F based on the mesh data. The thus generated corresponding point file F is output to the imprinting unit 100. The sound data acquired by the sound input unit 200 are also provided to the imprinting unit 100.

As indicated in FIG. 24, the first image I1 is also input to the imprinting unit 100. The imprinting unit 100 imprints the corresponding point file F and sound data into the image I1 and outputs an altered first image I1a to the image data storing unit 16. The image data storing unit 16 also stores the second image I2 and succeeding images. Encoding is completed once all of the images and sound data have been processed. It will be understood that the second image I2 may be imprinted with a corresponding point file F which is generated between the second image I2 and a third image I3 (not shown) as well as with subsequent sound data such that the processing may also be recursive.

In the decoding processing, the extracting unit 102 reads out the altered first image I1a from the image data storing unit 16 and extracts the corresponding point file F and the sound data. The extracted corresponding file F is transmitted to the intermediate image generator 18. The sound data may be decoded by a sound decoding unit (not shown) and transmitted to the reproduction unit 20 or may be decoded by the reproduction unit 20 itself.

The intermediate image generator 18 generates intermediate images between the first image I1 and the second image 12 from the corresponding file F, the first image I1 (which is acquired by removing the imprinted data from the altered first image I1a) and the second image I2 by performing interpolation. The first image I1, intermediate images and second image I2 are transmitted to the reproduction unit 20. The timing for outputting the images is adjusted to match with the output of the sound in the reproduction unit 20 and the motion picture is displayed.

It is to be noted that the first image I1 which is acquired by removing the imprinted data from the altered first image I1a is not necessarily completely equal to the original first image I1 before imprinting and extracting. A complete correspondence between the processed first image I1 and the original first image I1 will be realized if the imprint and extraction are lossless, however, if lossy, the images may not completely correspond to each other. This manner of thinking is also applicable to the sound data.

The communication unit 22 is provided at least partly in consideration of a situation in which the decoding side is remote and the encoding side (through the communications unit 22) transmits a coded data stream which merely seems to be a series of image frames, such as the altered first image I1a and the second image 12, in appearance. Naturally, storage rather than immediate display may be intended at the remote side.

As described above, according to this embodiment of the present invention, the reproduction of motion pictures can be realized. In particular, since the corresponding point information, which is utilized for reproducing the smooth motion picture, and the sound data therefor are imprinted into the key frames, only the key frames need to be transmitted. If the coded data stream is intercepted by a person without a properly authorized decoder, it will appear as a set of discrete image frames. Since this embodiment adopts the method of imprinting, higher security can be realized. Copyrights can be better protected because generally only the key frames will be displayed frame by frame even in a case where the encoded data stream is illegally copied.

It will be understood that there may be various alterations and modifications to the above described embodiments. For example, it is not necessary that the interpolation be performed temporally, that is, although encoding and decoding of the motion pictures are considered in the above-described embodiments of the present invention, spatial interpolation between multi viewpoint images can also be performed in a similar way. In this case, the sound data may be music or narration.

Further, the first image I1 and other images may also be compressed by various appropriate image compression methods. In this case, the compression may be performed separately from encoding, that is, incorporation of the information of the corresponding point into the images, according to the preferred embodiment of the present invention. With regard to decoding, it is sufficient if decompression processing and the interpolation of the images, which is one of the characteristic of this embodiment, are performed respectively.

Although the present invention has been described by way of exemplary embodiments, it should be understood that many changes and substitutions may be made by those skilled in the art without departing from the spirit and the scope of the present invention which is defined only by the appended claims.

What is claimed is:

1. An image processing method, comprising:
acquiring a plurality of images;
acquiring data which is to be utilized with the plurality of images; and
imprinting the data into the plurality of images.

2. A method according to claim 1, wherein the data comprises sound data which is to be reproduced together with the plurality of images when displaying the plurality of images.

3. An image processing apparatus, comprising:
an image input unit which acquires images;
a data unit which acquires data which is to be utilized with the images; and
an imprinting unit which imprints the data into the images.

4. An apparatus according to claim 3, wherein the data comprises sound data which is to be reproduced together with the images when displaying the images.

5. An apparatus according to claim 4, wherein the data further comprises information of corresponding points between images, which is to be utilized in generating intermediate images.

6. An image processing apparatus, comprising:
an image input unit which acquires a data stream from a motion picture;
an imprinting unit which imprints data into the acquired data stream, wherein the data has a different format from the data stream and is to be utilized with the data stream.

7. An apparatus according to claim 6, wherein the imprinted data comprises sound data, which is to be reproduced synchronously with the data stream when the data stream is displayed as a motion picture.

8. An apparatus according to claim 7, wherein the imprinted data further comprises information of corresponding points between image frames within the data stream.

9. An image processing apparatus, comprising:
an image input unit which acquires a plurality of key frames and information of corresponding points determined therebetween; and
an imprinting unit which imprints sound data into at least one of the key frames, wherein the sound data is to be reproduced synchronously with the key frames when displaying the key frames as a motion picture, including intermediate frames generated by interpolation based on the information of the corresponding points.

10. An image processing apparatus, comprising:
an image input unit which acquires a plurality of key frames;
a corresponding point information generator which determines information of corresponding points between the key frames;
an imprinting unit which imprints sound data into at least one of the key frames, wherein the sound data is to be reproduced synchronously with the key frames when displaying the key frames as a motion picture, including intermediate frames generated by interpolation based on the information of the corresponding points.

11. An apparatus according to claim 9, wherein the imprinting unit also imprints the information of the corresponding points into at least one of the key frames.

12. An apparatus according to claim 10, wherein the imprinting unit also imprints the information of the corresponding points into at least one of the key frames.

13. An apparatus according to claim 9, wherein the imprinting unit controls an amount of the sound data to be imprinted in accordance with a time interval between a key frame to which the sound data is to be imprinted and a key frame adjacent thereto.

14. An apparatus according to claim 10, wherein the imprinting unit controls an amount of the sound data to be imprinted in accordance with a time interval between a key frame to which the sound data is to be imprinted and a key frame adjacent thereto.

15. An apparatus according to claim 11, wherein the imprinting unit controls an amount of the sound data to be imprinted in accordance with a time interval between a key frame to which the sound data is to be imprinted and a key frame adjacent thereto.

16. An apparatus according to claim 12, wherein the imprinting unit controls an amount of the sound data to be imprinted in accordance with a time interval between a key frame to which the sound data is to be imprinted and a key frame adjacent thereto.

17. An apparatus according to claim 9, wherein the imprinting unit also imprints timing data for reproducing the key frames into at least one of the key frames.

18. An apparatus according to claim 10, wherein the imprinting unit also imprints timing data for reproducing the key frames into any one of the key frames.

19. An apparatus according to claim 11, wherein the imprinting unit also imprints timing data for reproducing the key frames into any one of the key frames.

20. An apparatus according to claim 12, wherein the imprinting unit also imprints timing data for reproducing the key frames into any one of the key frames.

21. An apparatus according to claim 13, wherein the imprinting unit also imprints timing data for reproducing the key frames into any one of the key frames.

22. An apparatus according to claim 14, wherein the imprinting unit also imprints timing data for reproducing the key frames into any one of the key frames.

23. An apparatus according to claim 15, wherein the imprinting unit also imprints timing data for reproducing the key frames into any one of the key frames.

24. An apparatus according to claim 16, wherein the imprinting unit also imprints timing data for reproducing the key frames synchronously with the sound data into at least one of the key frames.

25. An image processing method, comprising:
acquiring images; and
extracting data, which was previously imprinted into the images, therefrom, wherein the data is to be utilized with the acquired images.

26. A method according to claim 25, wherein the data is sound data and further comprising:
reproducing the sound data synchronously with the images when reproducing the images.

27. An image processing apparatus, comprising:
an image input unit which acquires images; and
an extracting unit which extracts data, which has previously been imprinted into the images, therefrom, wherein the data is to be utilized with the acquired images.

28. An apparatus according to claim 27,
wherein the extracted data comprises sound data, and
the apparatus further comprises a reproduction unit which reproduces the images as a motion picture and which reproduces the sound data synchronously with the motion picture.

29. An apparatus according to claim 28,
wherein the extracted data also comprises information of corresponding points which is used for interpolating the images, and
wherein the reproduction unit reproduces the motion picture by interpolation.

30. An image processing apparatus, comprising:
an image input unit which acquires key frames and information of corresponding points therebetween;
an extracting unit which extracts sound data which has been imprinted into the acquired key frames;
an intermediate image generator which generates at least one intermediate frame by interpolation based on the key frames and the information of the corresponding points; and
a reproduction unit which decodes the extracted sound data and outputs a motion picture formed by the key frames and the at least one intermediate frame synchronously with the decoded sound data.

31. An apparatus according to claim 30,,wherein the information of the corresponding points has also previously been imprinted into the key frames and the extraction unit extracts the information of corresponding points in addition to the sound data.

32. An apparatus according to claim 30, wherein the intermediate image generator acquires an instruction regarding a number of the intermediate frames to be generated and generates the intermediate frames in accordance with the instruction.

33. An apparatus according to claim 32, wherein the reproduction unit controls synchronism between the motion picture and the sound data according to the number of intermediate frames generated.

34. A computer program executable by a computer, said computer program adapting the computer for the functions of:
acquiring images;
acquiring data which is to be utilized with the images; and
imprinting the data into the images.

35. A computer program executable by a computer, said computer program adapting the computer for the functions of:
acquiring images; and
extracting data which was previously imprinted into the images, therefrom, wherein the data is to be utilized with the acquired images.

36. An image processing apparatus according to claim 10, wherein the corresponding point information generator determines information of corresponding points between the key frames using a multiresolutional critical point filter.
